(19) United States
(12) Patent Application Publication
(10) Pub. No.: US 2024/0337404 A1
(43) Pub. Date: Oct. 10, 2024

(54) MONITORING DEVICE FOR ENVIRONMENTAL IMPROVEMENT, AND CONTROL METHOD THEREFOR

(71) Applicant: Samsung Electronics Co., Ltd., Suwon-si (KR)

(72) Inventors: Odo YU, Suwon-si (KR); Jaeyu SEO, Suwon-si (KR); Hani YANG, Suwon-si (KR)

(73) Assignee: Samsung Electronics Co., Ltd., Suwon-si (KR)

(21) Appl. No.: 18/746,641

(22) Filed: Jun. 18, 2024

Related U.S. Application Data
(63) Continuation of application No. PCT/KR2022/018953, filed on Nov. 28, 2022.

(30) Foreign Application Priority Data
Jan. 28, 2022 (KR) 10-2022-0013616

(51) Int. Cl. F24F 11/63; G08B 21/18; H05B 47/105; H05B 47/16

(52) U.S. Cl. CPC F24F 11/63; G08B 21/18; H05B 47/105; H05B 47/16

(57) ABSTRACT

A monitoring apparatus based on a care mode is provided. In detail, the monitoring apparatus executes a care mode for a selected care subject, obtains at least one of movement data about the selected care subject and environmental data around the selected care subject, controls an operation of an external apparatus based on the obtained data, and outputs a notification when necessary.

### CROSS-REFERENCE TO RELATED APPLICATION

This application is a continuation application, under 35 U.S.C. § 111 (a), of international application No. PCT/KR2022/018953, filed on Nov. 28, 2022, which claims priority under 35 U. S. C. § 119 to Korean Patent Application No. 10-2022-0013616, filed Jan. 28, 2022, the disclosures of which are incorporated herein by reference in their entireties.

### TECHNICAL FIELD

An embodiment of the present disclosure relates to a monitoring apparatus for environmental improvement, capable of monitoring an indoor environment and controlling an operation of an external apparatus based on a result of the monitoring, and to a method of controlling the same.

### BACKGROUND ART

Monitoring apparatuses for environmental improvement are electronic apparatuses that monitor outdoor or indoor air quality. Monitoring apparatuses for environmental improvement may monitor an outdoor or indoor environment based on, for example, carbon dioxide (CO₂), temperature, and humidity. Such a monitoring apparatus monitors an outdoor or indoor environment by measuring CO₂, temperature, and humidity based on sensors and thus is sometimes referred to as an air quality measurement device or an air sensor monitor.

In order to improve the indoor environment based on a monitoring result from a monitoring apparatus for environmental improvement, a user has the inconvenience of having to operate at least one apparatus (e.g., an air cleaner, a humidifier, dehumidifier, and/or an air conditioner). For example, when a result of monitoring the indoor environment indicates that the concentration of CO₂ is higher than a reference value, the user needs to operate the air cleaner. When the result of monitoring the indoor environment indicates that the current temperature is higher than a reference value, the user needs to operate the air conditioner.

In order to solve the inconvenience for the user, automatic ventilation systems that automatically improve the indoor air quality by connecting monitoring apparatuses for environmental improvement with external apparatuses have been proposed.

However, the monitoring apparatuses for environmental improvement in the related art do not have an operation mode function based on a care subject. Accordingly, when a care subject is in an indoor space, it may be difficult to provide an indoor environment optimized for the care subject.

Also, when the monitoring apparatus for environmental improvement is located far from the care subject, it may take a lot of time to optimize the indoor environment around the care subject.

### DISCLOSURE

### Technical Solution

According to an embodiment of the present disclosure, a monitoring apparatus may include a communicator, a memory, an input receiver, at least one sensor, and at least one processor.

According to an embodiment of the present disclosure, the communicator may be configured to communicate with at least one external apparatus. According to an embodiment of the present disclosure, the memory may store one or more instructions. According to an embodiment of the present disclosure, the input receiver may be configured to receive an input setting an operation mode. According to an embodiment of the present disclosure, the at least one processor may be configured to execute the one or more instructions stored in the memory to select a care subject to be monitored through the input receiver. According to an embodiment of the present disclosure, the at least one processor may be configured to execute the one or more instructions stored in the memory to receive an input for executing a care mode for the selected care subject.

According to an embodiment of the present disclosure, the at least one processor may be configured to execute the one or more instructions stored in the memory to, in response to the received input, obtain, through the at least one sensor, sensed data including at least one of data regarding a movement of the selected care subject, data regarding temperature and humidity around the selected care subject, or data regarding air quality around the selected care subject. According to an embodiment of the present disclosure, the at least one processor may be configured to execute the one or more instructions stored in the memory to, based on the obtained sensed data, determine the at least one external apparatus is an environment improvement apparatus, or the at least one external apparatus is among the environment improvement apparatus enabled to control an environment around the selected care subject. According to an embodiment of the present disclosure, the at least one processor may be configured to execute the one or more instructions stored in the memory to transmit, through the communicator, to the environment improvement apparatus, an operation control signal related to improving the environment around the selected care subject.

According to an embodiment of the present disclosure, a method of controlling a monitoring apparatus may include, by at least one processor, receiving an input for selecting a care subject and executing a care mode for the selected care subject. According to an embodiment of the present disclosure, the method of controlling the monitoring apparatus may include, by the at least one processor, in response to the received input, obtaining, through at least one sensor included in the monitoring apparatus, sensed data including at least one of data regarding a movement of the selected care subject, data regarding temperature and humidity around the selected care subject, and data regarding air quality around the selected care subject. According to an embodiment of the present disclosure, the method of controlling the monitoring apparatus may include, by the at least one processor, based on the sensed data, determining at least one external apparatus is an environment improvement apparatus, or the at least one external apparatus is an environment improvement apparatus enabled to control an environment around the selected care subject, the monitoring apparatus including a communicator. According to an embodiment of the present disclosure, the method of controlling the monitoring apparatus may include, by the at least one processor, transmitting, through the communicator, to the environment improvement apparatus, an operation control signal related to improving the environment around the selected care subject.

### DESCRIPTION OF DRAWINGS

FIG. 1 is a diagram for describing an environment control system based on a monitoring apparatus, according to an embodiment of the present disclosure.

FIG. 2 is a diagram for describing an example of a configuration of a monitoring apparatus according to an embodiment of the present disclosure.

FIG. 3 shows an example of an external view of a monitoring apparatus according to an embodiment of the present disclosure.

FIG. 4 is a block diagram for describing functions of a monitoring apparatus according to an embodiment of the present disclosure.

FIG. 5 is a block diagram for describing functions of a monitoring apparatus according to an embodiment of the present disclosure.

FIG. 6A is an example diagram of vibration data obtained by a vibration sensor included in a monitoring apparatus, according to an embodiment of the present disclosure.

FIG. 6B is an example diagram of a waveform of wireless-fidelity (Wi-Fi) channel state information (CSI) received by a monitoring apparatus in a sleeping state of a care subject, according to an embodiment of the present disclosure.

FIG. 7 is a flowchart for describing a method of controlling a monitoring apparatus, according to an embodiment of the present disclosure.

FIG. 8 is a flowchart for describing a method of controlling a monitoring apparatus, according to an embodiment of the present disclosure.

FIG. 9 is a flowchart for describing a method of controlling a monitoring apparatus, according to an embodiment of the present disclosure.

FIG. 10 is a flowchart for describing a method of controlling a monitoring apparatus, according to an embodiment of the present disclosure.

FIG. 11 is a flowchart for describing a method of controlling a monitoring apparatus, according to an embodiment of the present disclosure.

FIG. 12 is a flowchart for describing a method of controlling a monitoring apparatus, according to an embodiment of the present disclosure.

FIG. 13 is a flowchart for describing operations of an environment control system based on a monitoring apparatus and an air conditioner, according to an embodiment of the present disclosure.

FIG. 14 is a flowchart for describing a method of controlling a monitoring apparatus, according to an embodiment of the present disclosure.

### MODE FOR INVENTION

It should be understood that the various embodiments of the present disclosure and the terms used herein are not intended to limit the technical features described in the present disclosure to specific embodiments, and include various modifications, equivalents, or alternatives of corresponding embodiments.

In relation to the description of drawings in the present disclosure, like reference numerals may denote like or relevant components. In addition, in order to clearly explain embodiments of the present disclosure with reference to the drawings, parts unrelated to the description are omitted.

In the present disclosure, the singular form of a noun corresponding to an item may include one item or a plurality of items, unless the relevant context clearly indicates otherwise.

Throughout the present disclosure, the expression “at least one of A, B, or C” indicates A only, B only, C only, both A and B, both A and C, both B and C, all of A, B, and C, or variations thereof. Throughout the disclosure, each of the phrases “A or B”, “at least one of A and B”, “at least one of A or B”, “A, B, or C”, “at least one of A, B, and C”, and “at least one of A, B, or C” may include any one of items listed together in the corresponding phrase, or any possible combinations thereof.

In the present disclosure, the term “and/or” includes any component of a plurality of components described herein or any combinations of the plurality of components. In the present disclosure, the terms “first”, “second”, or “first” or “second” may be simply used to distinguish a component from another component and do not limit the components in other aspects (e.g., importance or order).

In the present disclosure, when a certain (e.g., first) component is referred to as “coupled” or “connected” to another (e.g., second) component, with or without the terms “functionally” or “communicatively”, this means that the certain component may be connected to the other component directly (e.g., in a wired manner), wirelessly, or via a third component. As used herein, when a certain component is “connected to”, “combined with”, “supported by”, or “in contact with” another component, this includes cases where the components are directly connected to, combined with, supported by, or in contact with each other and cases where the components are indirectly connected to, combined with, supported by, or in contact with each other via a third component.

In the present disclosure, when a certain component is located on another component, this includes a case where the certain component is in contact with the other component and a case where another component is present between the two components.

All terms used in the present disclosure are those general terms currently widely used in the art in consideration of functions in regard to embodiments of the present disclosure, but the terms may vary according to the intention of those of ordinary skill in the art, precedents, or new technologies in the art. Furthermore, some particular terms may be arbitrarily selected by the applicant, and in this case, the meaning of the selected terms will be described in detail in the detailed description of the disclosure. Thus, the terms used in the present disclosure should be understood not as simple names but based on the meaning of the terms and the overall description of the disclosure.

Throughout the present disclosure, when a portion “includes” or “comprises” a component, another component may be further included, rather than excluding the presence of the other component, unless otherwise described. Throughout the present disclosure, the terms “include”, “comprise”, or “have” are intended to indicate the presence of features, numbers, steps, operations, components, parts, or combinations thereof described herein, and do not preclude the presence or addition of one or more other features, numbers, steps, operations, components, parts, or combinations thereof.

As used herein, the terms “ . . . or/er”, “ . . . module”, or the like refer to units that perform at least one function or operation, which may be implemented as hardware or software or as a combination of hardware and software.

Hereinafter, embodiments of the present disclosure will be described in detail with reference to the accompanying drawings such that one of ordinary skill in the art may easily implement the embodiments of the present disclosure. The present disclosure may, however, be embodied in many different forms and should not be construed as limited to the embodiments of the disclosure set forth herein.

According to an embodiment of the present disclosure, a monitoring apparatus for environmental improvement having a care subject-based operation mode function and a method of controlling the monitoring apparatus may be provided.

According to an embodiment of the present disclosure, a monitoring apparatus for environmental improvement, which monitors the state of a care subject and an environment around the care subject according to a care mode set by a user and controls an external apparatus based on a monitoring result, and a method of controlling the monitoring apparatus may be provided.

According to an embodiment of the present disclosure, a monitoring apparatus for environmental improvement, which monitors the state of a care subject and an environment around the care subject according to a care mode set by a user and provides a notification based on a monitoring result, and a method of controlling the monitoring apparatus may be provided.

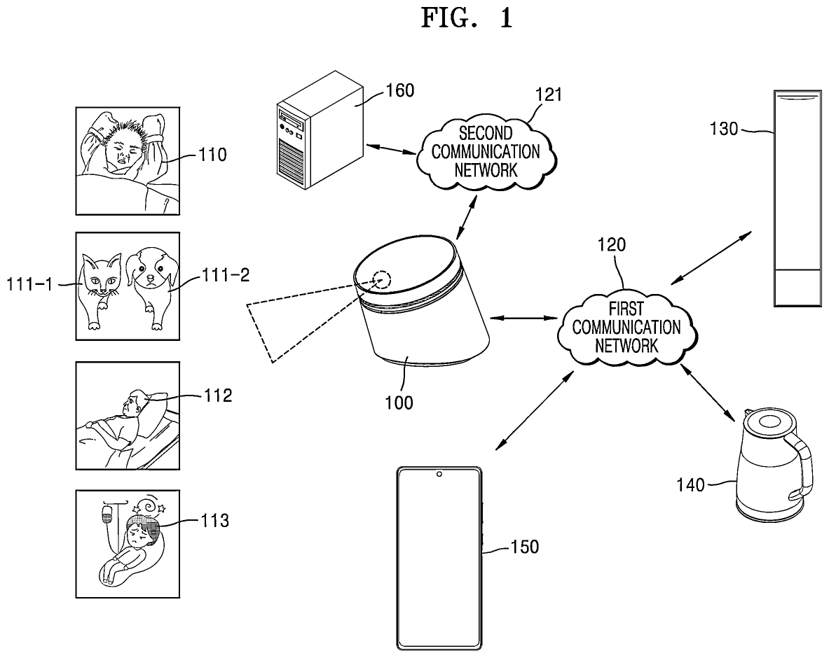

FIG. 1 is a diagram for describing an environment control system based on a monitoring apparatus 100, according to an embodiment of the present disclosure. The monitoring apparatus 100 may be referred to as a monitoring apparatus for environmental improvement. The environment control system shown in FIG. 1 may be referred to as an indoor environment control system that controls an indoor environment, in which the monitoring apparatus 100 is located, to be pleasant, an environment control system that controls an environment around the monitoring apparatus 100 to be pleasant, or a care subject management and environment control system that controls an environment around a care subject to be pleasant while monitoring the care subject. The monitoring apparatus 100 may be expressed as a monitoring apparatus.

According to an embodiment of the present disclosure, the care subject is a subject that needs to be taken care of, and as shown in FIG. 1, the care subject may include a newborn 110, companion animals 111-1 and 111-2, an elderly person 112, or a patient 113, but is not limited thereto.

According to an embodiment of the present disclosure, the monitoring apparatus 100 may be connected to an external apparatus, such as an air conditioner 130 and/or an electric kettle 140, based on a first communication network 120. Connection between the monitoring apparatus 100 and the air conditioner 130 and/or the electric kettle 140 based on the first communication network 120 may be performed by using a mobile device 150.

For example, when the first communication network 120 is a communication network based on a wireless-fidelity (Wi-Fi) wireless router, an application (e.g., a Wi-Fi-based external apparatus connection application) installed on the mobile device 150 may be executed such that the monitoring apparatus 100 is connected to the air conditioner 130 and the monitoring apparatus 100 is also connected to the electric kettle 140. The first communication network 120 may be configured based on a wired or wireless communication scheme.

The mobile device 150 is connected to the monitoring apparatus 100 through the first communication network 120. When the mobile device 150 is connected to the monitoring apparatus 100, the first communication network 120 may be based on a short-distance communication scheme such as Bluetooth or Wi-Fi direct (WFD).

Also, when the first communication network 120 is based on the short-distance scheme such as Bluetooth or WFD, the monitoring apparatus 100 may be connected, through the first communication network 120, to the air conditioner 130 and the electric kettle 140, which have a Bluetooth function or a WFD function and are located within a certain distance (e.g., 10 M).

The external apparatus that may be connected to the monitoring apparatus 100 based on the first communication network 120 is not limited to the air conditioner 130 and the electric kettle 140 shown in FIG. 1.

For example, the external apparatuses that may be connected to the monitoring apparatus 100 may include an environment improvement apparatus having a function for improving an indoor environment and a communication function. The environment improvement apparatus may include an air cleaner, a dehumidifier, and/or a humidifier, but is not limited thereto. The environment improvement apparatus mainly improves air quality and may thus be referred to as an air quality improvement apparatus. The environment improvement apparatus may include a ventilation system (e.g., a smart window), a curtain apparatus, or a clothes dryer.

For example, the external apparatus that may be connected to the monitoring apparatus 100 may include a care-related apparatus having a function related to a care subject and a communication function.

For example, when the care subject is the newborn 110, the care-related apparatus may include the electric kettle 140, an audio apparatus, and/or a mobile. For example, when the care subject is a companion animal 111-1 or 111-2, the care-related apparatus may include an automatic drinking fountain, an automatic feeding station, a television, a robot vacuum cleaner, an electric toy, and/or a smart toy. For example, when the care subject is the elderly person 112, the care-related apparatus may include an artificial intelligence assistant device and/or a care robot. For example, when the care subject is the patient 113, the care-related apparatus may include a bed device, an electric wheelchair, and/or a smart wheelchair.

The monitoring apparatus 100 may be configured to set a normal operation mode (or normal mode) or operation modes (or care modes) based on the care subjects 110, 111-1, 111-2, 112, and 113. When the operation mode based on the care subjects 110, 111-1, 111-2, 112, and 113 is set, the monitoring apparatus 100 may obtain data about the state of a care subject and data about an environment around the care subject according to the set care mode, and monitor the state of the care subject and the environment around the care subject. The monitoring apparatus 100 may be configured to select a care subject and execute a care mode for the care subject. For example, the monitoring apparatus 100 may be configured to set a newborn 110 mode, a companion animal mode, an elderly mode, or a patient mode.

Information regarding the state of the care subject may include, for example, movement data about the care subject, sound data about the care subject, and/or vibration data around the care subject, but is not limited thereto. The movement data about the care subject may include movement data about the care subject when the care subject is in a sleeping state. Environment data around the care subject may include air quality data, temperature data, and humidity data around the care subject, but is not limited thereto.

The monitoring apparatus 100 may determine whether the care subject has urinated and/or defecated, based on the movement data about the care subject, the sound data about the care subject, the vibration data around the care subject, and the environment data around the care subject. For example, when the monitoring apparatus 100 is set to a newborn mode, the monitoring apparatus 100 may determine whether the newborn 110 has defecated or urinated, based on a change in air quality around the newborn 110, a vibration detection result, and a sound detection result.

In this case, the monitoring apparatus 100 may determine a change in air quality by using a result of detecting malodor gas. To this end, the monitoring apparatus 100 may include a malodor gas sensor. The malodor gas sensor may be configured to detect the concentration of a compound, such as hydrogen sulfur, ammonia, and acetic acid.

When it is determined that the newborn 110 has defecated or urinated, the monitoring apparatus 100 may transmit, to the air conditioner 130, an operation control signal for the air conditioner 130 through the first communication network 120 to improve the air quality around the newborn 110, and may output a notification indicating that the newborn 110 has defecated and/or urinated, through a refrigerator (not shown) including the monitoring apparatus 100, the mobile device 150, the air conditioner 130, and/or a display. Accordingly, the newborn 110 who has defecated and/or urinated may be more quickly taken care of.

Based on a monitoring result, the monitoring apparatus 100 may control an operation of the air conditioner 130 and/or the electric kettle 140, which are connected through the first communication network 120. The electric kettle 140 is a smart electric kettle having a communication function and may be referred to as a care-related apparatus.

For example, when the operation mode of the monitoring apparatus 100 is set to the newborn mode and a result monitored by the monitoring apparatus 100 is determined to be outside temperature data and humidity data (e.g., temperature of about 21 degrees Celsius (° C.) to about 24° C. and humidity of about 40% to about 60%) optimized for the newborn 110, the monitoring apparatus 100 may transmit, to the air conditioner 130, an operation control signal for the air conditioner 130 through the first communication network 120 such that temperature data and humidity data around the newborn 110 become temperature data and humidity data corresponding to the newborn mode. The operation control signal transmitted to the air conditioner 130 is a signal for controlling the operation of the air conditioner 130 and may include a signal requesting the operation of the air conditioner 130 and information regarding a desired operation range. For example, the operation control signal transmitted to the air conditioner 130 may include an operation state, operation mode, set temperature, wind speed and strength, and/or wind direction.

As described above, the monitoring apparatus 100 may prevent the newborn 110 from developing a congenital fever, by controlling the indoor environment to be pleasant such that temperature data, humidity data, and air quality data around the newborn 110 correspond to temperature data, humidity data, and air quality data optimized for the newborn 110.

In addition, the monitoring apparatus 100 may obtain personal information about the care subject. For example, when the care subject is the newborn 110, the monitoring apparatus 100 may obtain data on a temperature and/or humidity at which the newborn 110 develops a congenital fever. The monitoring apparatus 100 may receive, from a user, inputs of data on a temperature and/or humidity at which the newborn 110 develops a congenital fever. The monitoring apparatus 100 may obtain personal information about the newborn 110 from information received from a server apparatus 160 through a second communication network 121.

Accordingly, according to an embodiment of the present disclosure, even when data on a temperature and humidity at which a congenital fever develops are different for each newborn 110, the newborn 110 may be prevented from developing a congenital fever. The temperature data, humidity data, and air quality data optimized for the newborn 110 may be referred to as recommended specification information.

The monitoring apparatus 100 may periodically transmit the monitoring result to the air conditioner 130 through the first communication network 120. As described above, when the monitoring result is periodically transmitted, the air conditioner 130 may determine an indoor environment and the state of the care subject based on received information and control the operation of the air conditioner 130 based on a determination result. The operation of the air conditioner 130 may include a wind strength control operation and a wind direction control operation, but is not limited thereto.

When the operation mode of the monitoring apparatus 100 is set to the newborn mode and the monitoring result indicates that a feeding time for the newborn 110 has arrived, the monitoring apparatus 100 may transmit, to the electric kettle 140, an operation control signal for the electric kettle 140 through the first communication network 120. The transmitted operation control signal is a signal for controlling an operation of the electric kettle 140 and may include a signal requesting a heating operation of the electric kettle 140. The transmitted operation control signal may further include information (e.g., 40° C.) regarding heating temperature of the electric kettle 140. In this case, the monitoring apparatus 100 may output a notification indicating that heating of the electric kettle 140 has been requested or may transmit notification data to the mobile device 150 connected to the monitoring apparatus 100 and/or the refrigerator (not shown) having a display function. Accordingly, the newborn 110 may be fed in a short period of time. The monitoring apparatus 100 may determine a feeding time for the newborn 110 based on the personal information about the newborn 110.

The mobile device 150 may include a cellular phone, a remote controller, a tablet personal computer (PC), or a wearable device (e.g., a smart watch or smart glasses), but is not limited thereto. The mobile device 150 may not have a smart home function. In order to perform the smart home function, the mobile device 150 may execute an application related to the smart home function, which is stored in the mobile device 150.

The mobile device 150 may directly transmit or receive data to or from the monitoring apparatus 100 through the first communication network 120 or may transmit or receive data to or from the monitoring apparatus 100 via the server apparatus 160.

When a movement of the newborn 110 is detected, the monitoring apparatus 100 may monitor temperature data, humidity data, and air quality data around the newborn 110 and based on a result of the monitoring, through the first communication network 120, may transmit, to the air conditioner 130, an operation control signal for the air conditioner 130 or transmit, to the electric kettle 140, an operation control signal for the electric kettle 140.

The monitoring apparatus 100 may monitor the sleeping state of the newborn 110 by analyzing Wi-Fi channel state information (CSI) received through the first communication network 120. When a result of monitoring the sleeping state of the newborn 110 indicates that a breathing state of the newborn 110 is abnormal, the monitoring apparatus 100 may output a notification indicating that the breathing state of the newborn 110 is abnormal or may transmit, through the first communication network 120, notification data to all devices or the mobile device 150 connected to the monitoring apparatus 100. Accordingly, when the newborn 110 is in an abnormal breathing state during sleep, a prompt measure may be made.

The monitoring apparatus 100 may detect the number of people around the newborn 110 by analyzing the Wi-Fi CSI received through the first communication network 120, and control the operation of the air conditioner 130 through the first communication network 120 such that air quality data, temperature data, and humidity data around the newborn 110 are optimized for the newborn 110 in a shorter period of time.

The monitoring apparatus 100 may operate by differently setting recommended temperature data and humidity data according to the season. The monitoring apparatus 100 may store the recommended temperature data and humidity data according to the season in advance. The monitoring apparatus 100 may download the recommended temperature data and humidity data according to the season from the server apparatus 160 connected through the second communication network 121.

The second communication network 121 may be based on a communication protocol different from that of the first communication network 120. For example, the second communication network 121 may be based on an Internet protocol (IP), whereas the first communication network 120 may be based on an open connectivity foundation (OCF) standard protocol. The second communication network 121 may be configured in a wired or wireless communication scheme.

The monitoring apparatus 100 may transmit changed detected data or periodically detected data to the server apparatus 160 through the second communication network 120. Accordingly, the server apparatus 160 may store data obtained by the monitoring apparatus 100 and manage sensing history information for the data obtained by the monitoring apparatus 100 and operation history information about the monitoring apparatus 100. The monitoring apparatus 100 may transmit the detected data to the server apparatus 160, for example, every 15 minutes. The server apparatus 160 may provide the stored sensing history information or operation history information about the monitoring apparatus 100 upon request from the mobile device 150. The mobile device 150 may control an operation of the monitoring apparatus 100 or change settings of the monitoring apparatus 100 based on the received sensing history information or operation history information about the monitoring apparatus 100.

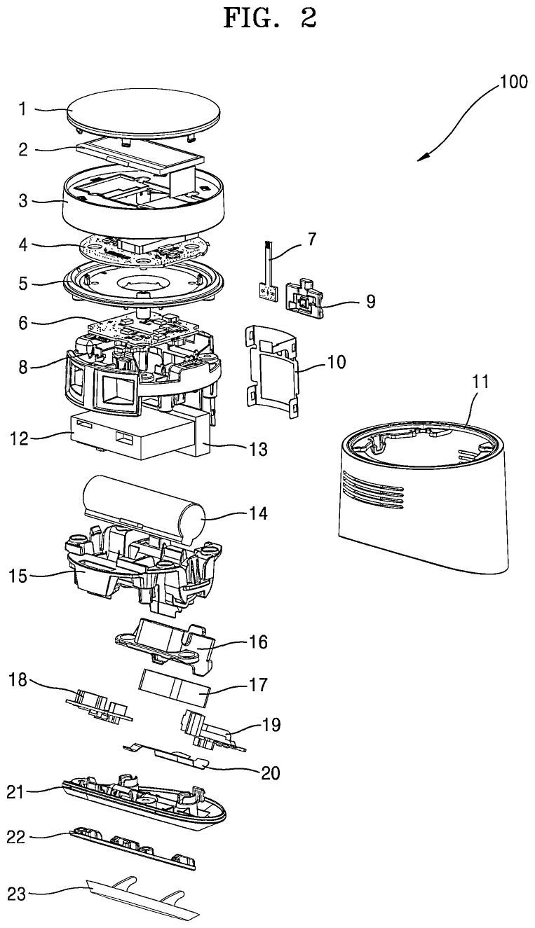

FIG. 2 is a diagram for describing an example of a configuration of a monitoring apparatus 100 according to an embodiment of the present disclosure.

Referring to FIG. 2, the monitoring apparatus 100 may include a window display 1, a liquid crystal display (LCD) 2, a case display 3, a main printed board assembly (PBA) 4, a case light-emitting diode (LED) 5, a sub PBA 6, a total volatile organic compound (TVOC) sensor 7, a cover sensor 8, a cap sensor 9, a plate rear 10, a cover body 11, a dust sensor 12, a CO₂ sensor 13, a battery 14, a case sensor 15, a case fan 16, a box fan 17, a power PBA 18, a temperature and humidity sensor 19, a cover bottom 21, a rubber leg 22, and a holder rack 23, but is not limited thereto.

Based on the window display 1 and the LCD 2 shown in FIG. 2, information regarding a care mode set in the monitoring apparatus 100, monitoring result information, notification information, time information, and/or date information may be provided. The monitoring result information may include temperature data, humidity data, and/or air quality data. The notification information may include Wi-Fi connection information and/or state information about the care subject. The state information about the care subject may include state information indicating an emergency state of the care subject or an abnormal state of the care subject.

A lighting such as a red, green, and blue (RGB) LED may be mounted on the case LED 5 shown in FIG. 2. The monitoring apparatus 100 may display four colors of blue, green, yellow, and red by using the RGB LED mounted on the case LED 5 according to monitored air quality, but is not limited thereto. Accordingly, a user may easily recognize the level of indoor air quality based on a displayed color of the RGB LED.

The monitoring apparatus 100 may control the color of the RGB LED based on air quality data excluding data obtained by the CO₂ sensor 13. The monitoring apparatus 100 may differently control a brightness level of the RGB LED according to the time information. For example, the monitoring apparatus 100 may control the brightness level of the RGB LED during the nighttime (e.g., evening or early morning hours) to be higher than the brightness level of the RGB LED during the day.

By using the TVOC sensor 7, the dust sensor 12, and the CO₂ sensor 13 shown in FIG. 2, the monitoring apparatus 100 may monitor air quality around the monitoring apparatus 100 or around the care subject. Monitoring the air quality around the monitoring apparatus 100 or around the care subject may be expressed as measuring or detecting the air quality around the monitoring apparatus 100 or around the care subject.

The TVOC sensor 7 may be configured to detect a total amount (or sum total) of about 30 types of volatile organic compounds (VOCs) including formaldehyde, benzene, toluene, xylene, styrene, etc. The TVOC sensor 7 may be configured as various types of gas sensors. For example, the TVOC sensor 7 may be configured to include at least one of a metal oxide semiconductor (MOS) gas sensor, a contact combustion gas sensor, an electrochemical gas sensor, a nondispersive infrared (NDIR) gas sensor, a photoacoustic gas sensor, a photoionization (PID) gas sensor, and/or liquefied natural gas (LNG)/liquefied petroleum gas (LPG) sensor, but is not limited thereto. The monitoring apparatus 100 may classify data obtained by the TVOC sensor 7 into a good level, a normal level, a bad level, and a very bad level and express the detected data in level units, but is not limited thereto.

The dust sensor 12 may detect dust in the air around the monitoring apparatus 100. The dust sensor 12 may be configured to detect each of the concentration of PM10, which is coarse particulate matter with a diameter of 10 μm or less, the concentration of PM2.5, which is fine particulate matter with a diameter of 2.5 μm or less, and the concentration of PM1.0, which is ultrafine particulate matter with a diameter of 1.0 μm or less. The monitoring apparatus 100 may classify data obtained by the dust sensor 12 into good, normal, bad, and very bad and express the detected data in numeric units, but is not limited thereto.

The CO₂ sensor 13 may detect the concentration of CO₂ around the monitoring apparatus 100. The monitoring apparatus 100 may classify data obtained by the CO₂ sensor 13 into a good level, a normal level, a bad level, and a very bad level and express the detected data in level units, but is not limited thereto.

For example, when the concentration of CO₂ detected by the CO₂ sensor 13 is less than or equal to 380 ppm, this represents the best air quality, the monitoring apparatus 100 may determine the air quality as a good level. For example, when the concentration of CO₂ detected by the CO₂ sensor 13 is less than or equal to 800 ppm, this represents overall pleasant and good air quality, the monitoring apparatus 100 may determine the air quality as a normal level. For example, when the concentration of CO₂ detected by the CO₂ sensor 13 is less than or equal to 1000 ppm, this represents air quality that needs improvement, the monitoring apparatus 100 may determine the air quality as a bad level. For example, when the concentration of CO₂ detected by the CO₂ sensor 13 is less than or equal to 1500 ppm, this represents air quality that may cause a person to feel uncomfortable, the monitoring apparatus 100 may determine the air quality as a very bad level.

The monitoring apparatus 100 may store information about general recommendation criteria related to the TVOC sensor 7, the dust sensor 12, and the CO₂ sensor 13 and information about recommendation criteria respectively corresponding to care subjects. The monitoring apparatus 100 may store the information about recommendation criteria in advance and may download and store the information about recommendation criteria from the mobile device 150 or the server apparatus 160.

For example, the temperature and humidity sensor 19 shown in FIG. 2 may be configured to detect temperature in units of 1° C. and humidity in units of 1%. For example, the monitoring apparatus 100 may display the temperature detected by the temperature and humidity sensor 19 on the LCD 2 in units of 1° C. and the detected humidity on the LCD 2 in units of 1%.

The cover sensor 8, the cap sensor 9, and the case sensor 15 shown in FIG. 2 are structures that fix sensors installed in the monitoring apparatus 100.

The case fan 16 and the box fan 17 shown in FIG. 2 may be configured to discharge heat generated according to the operation of the monitoring apparatus 100 to the outside.

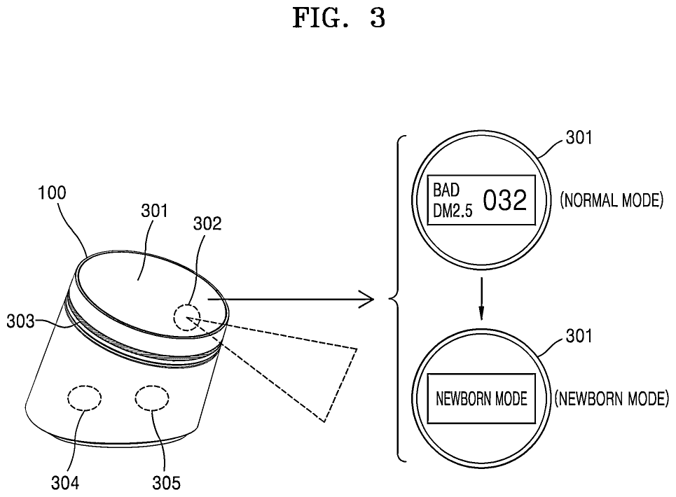

The monitoring apparatus 100 according to an embodiment of the present disclosure is not limited to the example shown in FIG. 2. For example, the monitoring apparatus 100 may include an infrared (IR) sensor that detects a movement of the care subject, a sound sensor that detects sound of the care subject, and/or a vibration sensor that detects vibration of the care subject. The monitoring apparatus 100 including the IR sensor, the sound sensor, and/or the vibration sensor will be described with reference to FIG. 3.

FIG. 3 shows an example of an external view of a monitoring apparatus 100 according to an embodiment of the present disclosure.

Referring to FIG. 3, the monitoring apparatus 100 may output, through a display 301, at least one of currently set operation mode information, time information, date information, and monitoring result information, but is not limited thereto. For example, when the monitoring apparatus 100 is in a normal mode, the monitoring apparatus 100 may display, on the display 301, air quality information (BAD), sensor information (PM2.5), and/or dust level information (032).

According to an embodiment of the present disclosure, the monitoring apparatus 100 may receive an input for changing the normal mode to a newborn mode. For example, the monitoring apparatus 100 may receive, as an input for setting the newborn mode, an input for pressing a button (or operation control button) mounted on the monitoring apparatus 100 three times in succession. When the monitoring apparatus 100 receives an input for pressing the button mounted on the monitoring apparatus 100 three times again, the newborn mode may be changed to the normal mode. Receiving the input for setting the newborn mode may refer to receiving an input for selecting the newborn mode and executing the selected newborn mode. As the number of button controls is set to 3, the intention to switch modes may be accurately determined, but the number of button controls is not limited as described above. Though the button mounted on the monitoring apparatus 100 is not shown in FIG. 3, the button may be provided on a touch basis through the display 301 or may be configured as a push button structure on the side of the monitoring apparatus 100, but is not limited thereto.

FIG. 3 shows an example in which the operation mode of the monitoring apparatus 100 is changed from the normal mode to the newborn mode.

The monitoring apparatus 100 may monitor a movement of the care subject by using an IR sensor 302. The IR sensor 302 includes a light emitter (e.g., an LED) that generates IR rays and a light receiver (or light sensor) that detects IR rays. The IR sensor 302 may detect a movement of the care subject based on the amount of IR rays generated from the light emitter and the amount of light reflected by the care subject and detected by the light receiver. The amount of light detected by the light receiver may be expressed as a voltage value or a current value.

A lighting 303 shown in FIG. 3 may be fixed by the case LED 5 shown in FIG. 2. The lighting 303 corresponds to the RGB LED described with reference to FIG. 2. Accordingly, the monitoring apparatus 100 may control the lighting 303 to display four colors of blue, green, yellow, and red through the lighting 303 according to monitored air quality. Therefore, a user may easily recognize the level of indoor air quality based on a displayed color of the RGB LED.

The monitoring apparatus 100 may control the lighting 303 such that a brightness level of light emitted from the lighting 303 varies according to time information. For example, the monitoring apparatus 100 may control the lighting 303 such that the brightness level of light emitted from the lighting 303 during the nighttime (or evening and early morning hours) is higher than the brightness level of light emitted from the lighting 303 during the day.

A vibration sensor 304 shown in FIG. 3 may detect vibration around the care subject. The vibration sensor 304 may be configured as a gyro sensor or a microelectromechanical system (MEMS) sensor. The monitoring apparatus 100 may determine whether the care subject has moved, based on vibration data obtained by the vibration sensor 304.

A sound sensor 305 shown in FIG. 3 may detect a sound signal of the care subject. The sound sensor 305 may be configured as a microphone. The monitoring apparatus 100 may determine the state of the care subject, based on sound data obtained by the sound sensor 305. For example, the monitoring apparatus 100 may determine whether the care subject has woken up from sleep, based on the sound data obtained by the sound sensor 305. For example, when it is determined that the newborn 110 has woken up from sleep, based on the sound data (e.g., crying sound) detected by the sound sensor 305, in a state in which the monitoring apparatus 100 is set to a newborn sleep mode, the monitoring apparatus 100 may display, through the display 301, a notification indicating that the newborn 110 is awake.

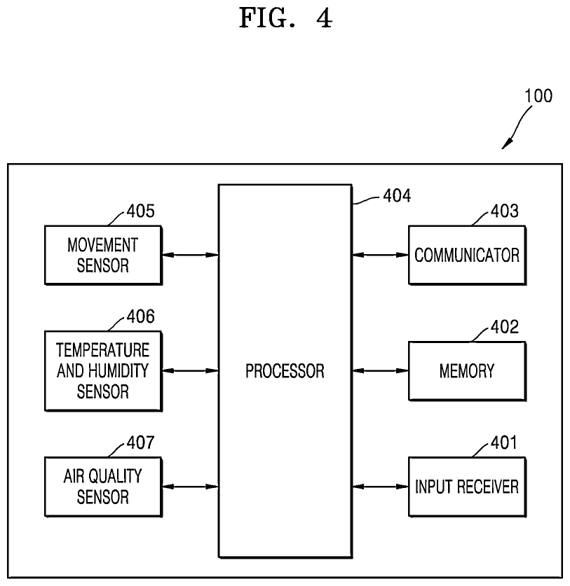

FIG. 4 is a block diagram for describing functions of a monitoring apparatus 100 according to an embodiment of the present disclosure.

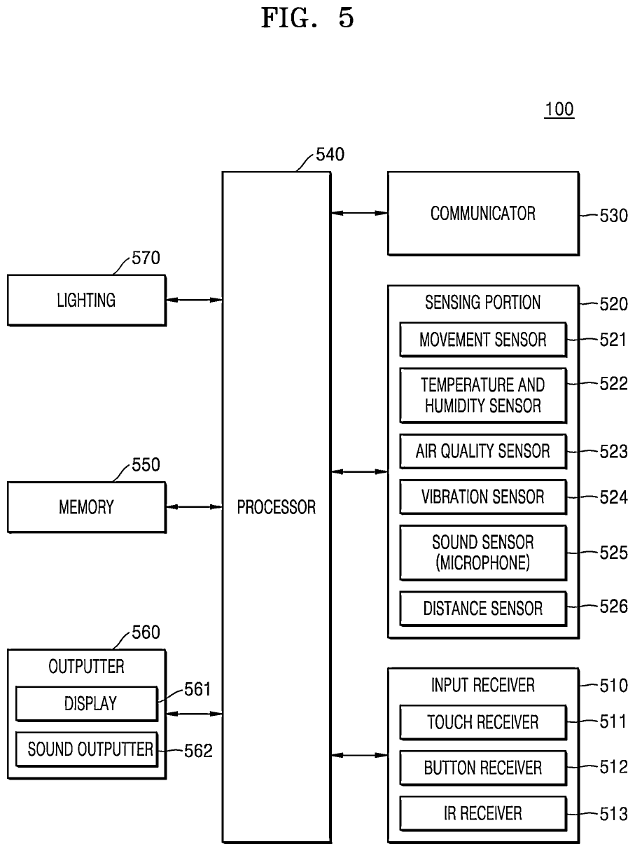

Referring to FIG. 4, the monitoring apparatus 100 includes an input receiver 401, a memory 402, a communicator 403, a processor 404, a movement sensor 405, a temperature and humidity sensor 406, and an air quality sensor 407, but the configuration of the monitoring apparatus 100 according to an embodiment of the present disclosure is not limited to that shown in FIG. 4. For example, the monitoring apparatus 100 according to an embodiment of the present disclosure may be configured as shown in FIG. 5 to be described below.

The input receiver 401 receives an input for setting an operation mode. The operation mode may include a normal mode and a care mode. The care mode may include a single care mode. The single care mode may include, for example, a newborn mode. The care mode may include a plurality of care modes. The plurality of care modes may include a newborn mode, a companion animal mode, an elderly mode, and a patient mode. When the plurality of care modes are provided, the input receiver 401 may receive an input for setting the selected care mode or an input for executing the selected care mode.

The care mode may include a care subject state mode in a lower layer. The care subject state mode is a mode that represents the state of the care subject. The care subject state mode may include, for example, a care subject sleep mode. The care subject state mode may be configured to select, for example, the care subject sleep mode and a care subject non-sleep mode. When the care subject state mode is included in a detail care mode of the care mode, the input receiver 401 may receive an input for selecting the care subject and then receive an input for selecting the care subject state mode. For example, the input receiver 401 may receive an input for selecting the newborn mode and then receive an input for selecting a newborn sleep mode or an input for executing the newborn sleep mode. To this end, the input receiver 401 may receive an input based on a user interface (UI) that allows selection of a care subject and a UI that allows selection or execution of the state of the selected care subject.

The input receiver 401 may be configured to receive a touch-based input and output received input data to the processor 404. The touch-based input may include a UI-based input. The input receiver 401 may be configured to receive a button-based input and output received input data to the processor 404. The input receiver 401 may be configured to receive and modulate an IR signal transmitted from a remote controller and output modulated data to the processor 404.

The memory 402 stores one or more instructions executed by the processor 404 and data corresponding to data monitored by the monitoring apparatus 100. The one or more instructions stored in the memory 402 are instructions that may perform a method of controlling the monitoring apparatus 100 according to an embodiment of the present disclosure. The one or more instructions stored in the memory 402 may be expressed as one or more programs.

The data stored in the memory 402 may include reference data related to data obtained by each of the movement sensor 405, the temperature and humidity sensor 406, and the air quality sensor 407. The reference data stored in the memory 402 may include data based on recommendation specifications. The reference data stored in the memory 402 may be divided and stored according to an operation mode that may be set in the monitoring apparatus 100. For example, the reference data stored in the memory 402 may be stored by being divided into the normal mode and the care mode. The reference data stored in the memory 402 may be divided and stored for each care mode. The reference data stored in the memory 402 may be stored by being divided into, for example, the newborn mode, the companion animal mode, the elderly mode, and the patient mode.

The reference data stored in the memory 402 may be divided and stored according to seasons. For example, the reference data stored in the memory 402 may be stored by being divided into spring, summer, fall, and winter.

The memory 402 may include a nonvolatile memory or nonvolatile semiconductor memory device, such as read-only memory (ROM), high-speed random access memory (RAM), magnetic disk storage device, and flash memory device. For example, the memory 402 is a semiconductor memory device and may use a secure digital (SD) memory card, a secure digital high capacity (SDHC) memory card, a mini SD memory card, a mini SDHC memory card, a trans flash (TF) memory card, a micro SD memory card, a micro SDHC memory card, a memory stick, a compact flash (CF) card, a multimedia card (MMC), a micro MMC, an extreme digital (XD) card, or the like. The memory 402 may be referred to as a storage. Also, the memory 402 may include a network-attached storage device accessed through a network.

The communicator 403 may be configured to communicate with at least one external apparatus in a wired or wireless manner. The communicator 403 may be connected to at least one external apparatus through the first communication network 120. The at least one external apparatus may include an environment improvement apparatus such as the air conditioner 130 shown in FIG. 1 and a care-related apparatus such as the electric kettle 140 shown in FIG. 1. The communicator 403 may be connected to the server apparatus 160 through the second communication network 121.

The communicator 403 may include, for example, a short-distance communication module, a wired communication module, and a mobile communication module.

The short-distance communication module may be a module for short-distance communication within a certain distance. Short-distance communication technology may include a wireless local area network (LAN), Wi-Fi, Bluetooth, ZigBee, WFD, ultra-wideband (UWB), infrared data association (IrDA), Bluetooth low energy (BLE), or near-field communication (NFC), but is not limited thereto.

The wired communication module refers to a module for communication using electrical signals or optical signals. Wired communication technology may include a pair cable, a coaxial cable, a fiber optic cable, or an ethernet cable, but is not limited thereto.

The mobile communication module may transmit and receive wireless signals to and from at least one of a base station, an external terminal, and a server apparatus through a mobile communication network. The wireless signals may include various types of data based on transmission and reception of voice call signals, video call signals, or text/multimedia messages.

The processor 404 is configured to control all functions of the monitoring apparatus 100 and may thus be expressed as a controller or microcontroller. The processor 404 may be configured to execute the one or more instructions stored in the memory 402 to receive, through the input receiver 401, an input for selecting an operation mode and executing the selected operation mode, in response to receiving the input, obtain, through each of at least one sensor including the movement sensor 405, the temperature and humidity sensor 406, and the air quality sensor 407, data regarding a movement of the care subject, temperature and humidity data around the care subject, and air quality data around the care subject, based on at least one of the data regarding the movement of the care subject, the temperature and humidity data around the care subject, and/or the air quality data around the care subject, determine an environment improvement apparatus capable of improving an environment around the care subject from among external apparatuses 130 and 140 connected through the communicator 403, and transmit an operation control signal related to environmental improvement to the determined environment improvement apparatus.

For example, when it is predicted that the care subject tossed and turned during sleep, based on at least one of the obtained data regarding the movement of the care subject, temperature and humidity data around the care subject, and air quality data around the care subject, the processor 404 may determine the air conditioner 130 as an environment improvement apparatus around the care subject in order to improve the environment around the care subject. The processor 404 may transmit, to the air conditioner 130, through the communicator 403, an operation control signal related to improving the environment around the care subject. After the environment improvement apparatus around the care subject is determined, the processor 404 may determine an operation control signal to be provided to the environment improvement apparatus around the care subject, based on at least one of the obtained temperature and humidity data or air quality data. For example, the processor 404 may determine a signal for controlling wind strength or wind direction of the air conditioner 130 based on at least one of the obtained temperature and humidity data or air quality data.

The movement sensor 405 may be configured as the IR sensor 302 shown in FIG. 3. The movement sensor 405 may include a light emitter that emits IR rays and a light receiver that receives IR rays. The movement sensor 405 may detect a movement around the monitoring apparatus 100. The movement sensor 405 may transmit detected movement data (e.g., a digital sensor signal) to the processor 404. Accordingly, the processor 404 may determine the movement of the care subject by comparing digital data about a current value or voltage value for the amount of received light transmitted from the movement sensor 405 with the reference data stored in the memory 402. The processor 404 may obtain movement data from a signal output from the movement sensor 405. The obtained movement data may include digital data about the current value or voltage value for the amount of light received by the movement sensor 405. When the monitoring apparatus 100 is executing the care mode, in order to accurately detect the movement of the care subject based on IR rays, the monitoring apparatus 100 needs to be positioned such that the IR rays are directed toward the care subject.

The temperature and humidity sensor 406 detects atmospheric temperature and humidity by using a capacitive humidity sensor and a thermistor. The temperature and humidity sensor 406 transmits detected data (e.g., a digital sensor signal) to the processor 404. The capacitive humidity sensor included in the temperature and humidity sensor 406 may be configured to measure a change in resistance between two electrodes and output the measured change in resistance as detected humidity data. The temperature and humidity sensor 406 may be configured as a resistive humidity sensor or a thermal humidity sensor. The thermistor included in the temperature and humidity sensor 406 may be configured to measure a resistance value that changes according to a change in temperature and output the measured resistance value (e.g., a digital sensor signal) as detected temperature data.

The air quality sensor 407 detects air quality in the air. The air quality sensor 407 transmits detected data (e.g., a digital sensor signal) to the processor 404. The air quality sensor 407 may include the TVOC sensor 7, the dust sensor 12, and the CO₂ sensor 13, which are mentioned with reference to FIG. 2. The air quality sensor 407 detects the concentrations of TVOCs, dust, and CO₂ in the air by using the TVOC sensor 7, the dust sensor 12, and the CO₂ sensor 13. The air quality sensor 407 may transmit, to the processor 404, detected data about the concentrations of TVOCs, dust, and CO₂ as detected air quality data.

FIG. 5 is a block diagram for describing functions of a monitoring apparatus 100 according to an embodiment of the present disclosure.

The monitoring apparatus 100 shown in FIG. 5 includes an input receiver 510, a sensing portion 520, a communicator 530, a processor 540, an outputter 560, a memory 550, and a lighting 570. The monitoring apparatus 100 according to an embodiment of the present disclosure is not limited to that shown in FIG. 5.

Like the input receiver 401 in FIG. 4, the input receiver 510 may be configured to receive a user input including an input for selecting an operation mode and transmit received input data to the processor 540. The input receiver 510 may include a touch receiver 511, a button receiver 512, and an IR receiver 513, but is not limited thereto. The input for selecting the operation mode may include an input for selecting a care subject and an input for executing a care mode for the selected care subject.

The touch receiver 511 may be configured to receive a touch-based input and transmit received input data to the processor 540. The touch receiver 511 may be formed as a single body with a display 561 included in the outputter 560. When the touch receiver 511 and the display 561 are formed as a single body, this may be expressed as a touch screen. The touch receiver 511 may be configured as a touch sensor. The touch-based input may include an input for selecting an operation mode of the monitoring apparatus 100, a power on/off input, an input for selecting other operations of the monitoring apparatus 100, or an input for selecting an operation condition, but is not limited thereto.

The button receiver 512 may be configured to a push button-based input and transmit received data to the processor 540. The button receiver 512 may be configured to receive an input based on an ON/OFF toggle switch.

The IR receiver 513 may be configured to receive and demodulate an IR signal wirelessly transmitted from a remote controller and transmit demodulated data to the processor 540. The IR receiver 513 may be expressed as an IR reception sensor.

The sensing portion 520 may be mounted on the monitoring apparatus 100 and configured to detect an environment around the monitoring apparatus 100 and transmit detected data to the processor 540. The sensing portion 520 may include a movement sensor 521, a temperature and humidity sensor 522, an air quality sensor 523, a vibration sensor 524, a sound sensor (microphone) 525, and/or a distance sensor 526, but is not limited thereto.

Like the movement sensor 405 in FIG. 4, the movement sensor 521 may be configured to detect a movement around the monitoring apparatus 100 and transmit detected data to the processor 540. The movement sensor 521 may be configured as the IR sensor 302 shown in FIG. 3. When the care mode is being executed as the operation mode of the monitoring apparatus 100, the movement sensor 521 may detect a movement of the care subject.

Like the temperature and humidity sensor 406 in FIG. 4, the temperature and humidity sensor 522 may be configured to detect temperature and humidity around the monitoring apparatus 100 and transmit detected data to the processor 540.

Like the air quality sensor 407 in FIG. 4, the air quality sensor 523 may be configured to detect air quality around the monitoring apparatus 100 and transmit detected data to the processor 540.

Like the vibration sensor 304 in FIG. 3, the vibration sensor 524 may be configured to detect vibration around the monitoring apparatus 100 and transmit detected data to the processor 540.

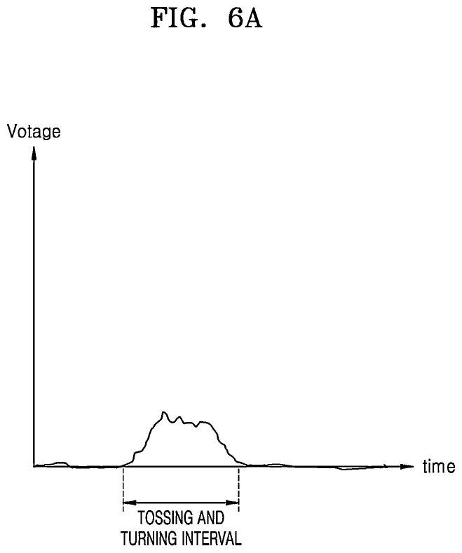

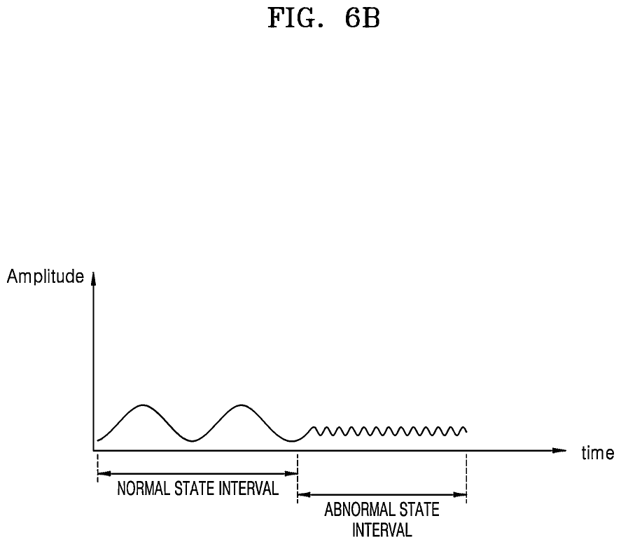

FIG. 6A is an example diagram of vibration detection, which is obtained by a vibration sensor 524 included in a monitoring apparatus 100, according to an embodiment of the present disclosure. Referring to FIG. 6A, a voltage value of an interval in which the newborn 110 tossed and turned is detected as a higher value than a voltage value before the interval in which the newborn 110 tossed and turned and after the interval in which the newborn 110 tossed and turned. The processor 540 may determine that the newborn 110 is tossing and turning, based on vibration data obtained as shown in FIG. 6A.

Like the sound sensor 305 in FIG. 3, the sound sensor (microphone) 525 may be configured to detect a sound signal around the monitoring apparatus 100 and transmit detected sound data to the processor 540.

The distance sensor 526 may be configured to detect distance data between the monitoring apparatus 100 and the care subject and transmit the detected distance data to the processor 540. The distance sensor 526 may include at least one of an ultrasonic sensor, an IR sensor, a lidar (“light detection and ranging” or “laser imaging, detection, and ranging”) sensor, a radar sensor, or a camera sensor.

Like the communicator 403 in FIG. 4, the communicator 530 may be configured to communicate with at least one external apparatus in a wired or wireless manner. The communicator 530 may be configured to communicate with at least one external apparatus through the first communication network 120. The at least one external apparatus may include the air conditioner 130 and the electric kettle 140, which are shown in FIG. 1. The communicator 530 may be configured to communicate with the server apparatus 160 through the second communication network 121, but is not limited thereto.

Like the communicator 403 in FIG. 4, the communicator 530 may include, for example, a short-distance communication module, a wired communication module, and a mobile communication module.

The processor 540 is configured to control all functions of the monitoring apparatus 100 and may thus be expressed as a controller or microcontroller. The processor 540 may execute one or more instructions stored in the memory 550 to receive an input through the input receiver 510. In response to the received input, the processor 540 may obtain data obtained by each of the movement sensor 521, the temperature and humidity sensor 522, the air quality sensor 523, the vibration sensor 524, the sound sensor 525, and the distance sensor 526, which are included in the sensing portion 520. The processor 540 may determine an external apparatus to operate based on at least one of obtained data regarding a movement, temperature and humidity data, air quality data, vibration data, sound data, and distance data. The processor 540 may be configured to transmit an operation control signal to the determined external apparatus.

The input received through the input receiver 510 may include an input for selecting a care subject and an input for selecting a care mode for the selected care subject. The external apparatus may include at least one external apparatus connected through the communicator 530. For example, the at least one external apparatus may include the air conditioner 130 and/or the electric kettle 140, which are shown in FIG. 1, but is not limited thereto. For example, in a case where the at least one external apparatus connected through the communicator 530 includes the air conditioner 130 and the electric kettle 140, when it is predicted that the care subject has woken up based on the obtained sound data and when it is determined that a feeding time has arrived, the processor 540 may determine, from among the at least one external apparatus, the electric kettle 140 as an apparatus to be controlled. In this case, when the care subject is the newborn 110, the processor 540 may determine whether the feeding time has arrived, based on management information (or newborn profile information) related to the newborn 110, which is stored in the memory 550. The processor 540 may transmit an operation control signal to the electric kettle 140 such that the determined electric kettle 140 performs a heating operation. In this case, the electric kettle 140 may be expressed as a care-related apparatus.

In a case where a current operation mode of the monitoring apparatus 100 is a newborn mode, when data obtained by the sound sensor 525 is determined to be a crying sound of the newborn 110, the processor 540 may determine whether crying of the newborn 110 is due to a desire to be fed or due to defecation. The processor 540 may determine the meaning of the crying of the newborn 110, based on the management information (or newborn profile information) related to the newborn 110, which is stored in the memory 550, and data obtained by the air quality sensor 523. The meaning of the crying of the newborn 110 may include a desire of the newborn 110 to be fed or defecation of the newborn 110, but is not limited thereto.

For example, when the crying of the newborn 110 is determined to be due to the desire to be fed, the processor 540 transmits, to the electric kettle 140, through the communicator 530, an operation control signal for controlling the electric kettle 140 to be heated. For example, when the crying of the newborn 110 is determined to be due to defecation, the processor 540 may transmit, to the air conditioner 130, through the communicator 530, an operation control signal for the air conditioner 130 such that the air conditioner 130 may control air quality around the newborn 110 to be pleasant in a short period of time, and may control an operation of the display 561 and/or a sound outputter 562 of the outputter 560 to output a notification indicating defecation of the newborn 110.

The processor 540 may transmit, through the communicator 530, a control signal for controlling an operation of at least one external apparatus, based on data obtained by the movement sensor 521, the temperature and humidity sensor 522, the air quality sensor 523, and the vibration sensor 524. For example, in a case where the operation mode of the monitoring apparatus 100 is the newborn mode, when the newborn 110 is determined to be tossing and turning during sleep based on the data obtained by the movement sensor 521, the temperature and humidity sensor 522, the air quality sensor 523, and the vibration sensor 524, the processor 540 may transmit, to the air conditioner 130, through the communicator 530, an operation control signal for the air conditioner 130 such that the air quality around the newborn 110 becomes more pleasant. In addition, when an audio apparatus is included in the external apparatus connected through the communicator 530, the processor 540 may determine the audio apparatus as an environment improvement apparatus and transmit, to the audio apparatus, an operation control signal to output white noise or a lullaby through the communicator 530.

The processor 540 extracts Wi-Fi CSI by analyzing a Wi-Fi signal received through the communicator 530. The processor 540 may analyze a change in amplitude and waveform of the extracted Wi-Fi CSI by using a program (e.g., an artificial intelligence model) stored in the memory 550. The processor 540 may detect fine movements caused by breathing and heart rate of the care subject, based on the change in amplitude of the Wi-Fi CSI.

For example, based on the change in amplitude and waveform of the received Wi-Fi CSI, the processor 540 may determine whether a breathing state of a newborn, which is the care subject, is normal or abnormal. For example, when there is a change in amplitude and waveform of the Wi-Fi CSI, the processor 540 may determine that the breathing state of the newborn is normal. For example, when there is no change in amplitude and waveform of the Wi-Fi CSI, the processor 540 may determine that the breathing state of the newborn is an abnormal state.

Also, the processor 540 may detect, based on the change in amplitude and waveform of the Wi-Fi CSI, whether the care subject tosses and turns, whether the care subject changed his or her head direction, whether the care subject is in light sleep, and/or whether the care subject is in deep sleep. What is detected by the processor 540 based on the Wi-Fi CSI is not limited to the above. For example, based on the change in amplitude and waveform of the Wi-Fi CSI, the processor 540 may detect the number of people around the care subject. Extracting Wi-Fi CSI from a received Wi-Fi signal and detecting a surrounding environment may be expressed as Wi-Fi sensing.

Also, the processor 540 may be configured to determine the meaning of the Wi-Fi CSI extracted from the received Wi-Fi signal through machine learning for the received Wi-Fi CSI. Machine learning for the Wi-Fi CSI refers to determining the meaning of the Wi-Fi CSI based on feature extraction and classification operations for the Wi-Fi CSI. In order to perform machine learning for the received Wi-Fi CSI, the memory 550 may store a program for machine learning on the Wi-Fi CSI.

FIG. 6B is an example diagram of a waveform of Wi-Fi CSI received by a monitoring apparatus in a sleeping state of a care subject, according to an embodiment of the present disclosure. As shown in FIG. 6B, the processor 540 may predict whether the breathing state of the care subject is normal or abnormal, by analyzing an amplitude of a waveform of the Wi-Fi CSI. As shown in FIG. 6B, when the waveform of the Wi-Fi CSI is detected as normal, the processor 540 may determine that the breathing state of the care subject is normal, and when the waveform of the Wi-Fi CSI is detected as an abnormal waveform, the processor 540 may determine that the breathing state of the care subject is abnormal.

The outputter 560 includes the display 561 and the sound outputter 562, but is not limited thereto. The display 561 may be controlled by the processor 540 to display information regarding an operation mode selected in the monitoring apparatus 100, time information, detected temperature and humidity data, and air quality data. The sound outputter 562 may output a notification indicating that the care subject needs to be taken care of. When distance data between the care subject and a location where the monitoring apparatus 100 is placed is greater than preset distance data, the sound outputter 562 may output a notification. Notification output based on the distance data between the care subject and the location where the monitoring apparatus 100 is placed may be performed based on periodic monitoring results.

For example, when the monitoring apparatus 100 is first installed, a notification is output based on distance data between the monitoring apparatus 100 and the care subject, and accordingly, a distance between the care subject and the monitoring apparatus 100 is adjusted. Then, when the distance data between the monitoring apparatus 100 and the care subject is greater than the preset distance data based on a movement of the care subject, the monitoring apparatus 100 may output a notification through the sound outputter 562. The sound outputter 562 may be configured as, for example, a speaker.

Like the memory 402 in FIG. 4, the memory 550 stores at least one instruction and data. The at least one instruction stored in the memory 550 may be executed by the processor 540 to perform the method of controlling the monitoring apparatus 100 according to an embodiment of the present disclosure. The data stored in the memory 550 may include data stored in the memory 402 of FIG. 4, and the memory 550 may further store data necessary for the processor 540 to perform processes related to the vibration sensor 524, the sound sensor 525, and the distance sensor 526. Also, the memory 550 may further store data necessary for the processor 540 to control an operation of the lighting 570.

The memory 550 may store a program and data necessary to detect a movement of the care subject based on Wi-Fi CSI received through the communicator 530. The program stored in the memory 550 to use the Wi-Fi CSI may include a program such as a dynamic time warping (DTW) algorithm. The memory 550 may store a program necessary for the processor 540 to perform machine learning based on the Wi-Fi CSI.

The lighting 570 may be configured like the lighting 303 configured as an RGB LED, which is described with reference to FIG. 3, and may be controlled by the processor 540. The processor 540 may control the lighting 570 such that a brightness level of light emitted from the lighting 570 varies according to time information. For example, the processor 540 may control the lighting 570 such that the brightness level of light emitted from the lighting 570 during the nighttime (or evening and early morning hours) is higher than the brightness level of light emitted from the lighting 570 during the day.

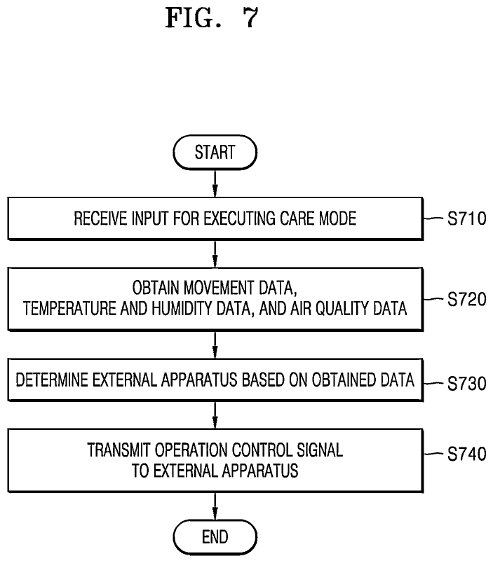

FIG. 7 is a flowchart for describing a method of controlling a monitoring apparatus 100, according to an embodiment of the present disclosure. The flowchart of FIG. 7 is performed when the monitoring apparatus 100 is capable of communicating, through the first communication network 120, with at least one external apparatus including the air conditioner 130 and/or the electric kettle 140. Connection between the monitoring apparatus 100 and the at least one external apparatus based on the first communication network 120 may be performed by the mobile device 150 or may be performed based on the input receiver 401 or 510 included in the monitoring apparatus 100.

In operation S710, the processor 404 or 540 of the monitoring apparatus 100 receives, through the input receiver 401 or 510, an input for selecting a care subject and an input for executing a care mode for the care subject. The input for selecting the care subject and the input for executing the care mode may include a touch-based input or button-based input through the input receiver 401 or 510, as described with reference to FIGS. 4 and 5. The input for selecting the care subject and the input for executing the care mode may include an input based on an IR signal received from a remote controller (not shown). The input for selecting the care subject and the input for executing the care mode for the selected care subject may be expressed as an input for setting a care mode of the monitoring apparatus 100.

In operation S720, in response to the inputs, the processor 404 or 540 of the monitoring apparatus 100 obtains, through at least one sensor 405, 406, 407, or 520 included in the monitoring apparatus 100, data regarding a movement of the care subject, temperature and humidity data around the care subject, and air quality data around the care subject. The data regarding the movement of the care subject is provided from Wi-Fi CSI received through the movement sensor 405 or 521, the vibration sensor 524, or the communicator 530. The temperature and humidity data around the care subject is provided from the temperature and humidity sensor 406 or 522. The air quality data around the care subject is provided from the air quality sensor 407 or 523.

According to an embodiment of the present disclosure, the processor 404 or 540 may detect the number of people around the care subject by using Wi-Fi CSI extracted from a Wi-Fi signal received through the communicator 403 or 530.

In operation S730, the processor 404 or 540 of the monitoring apparatus 100 may determine a care-related apparatus or an environment improvement apparatus capable of improving an environment around the care subject from among at least one external apparatus connected through the communicator 403 or 530, based on at least one of the obtained data regarding the movement of the care subject, temperature and humidity data around the care subject, and air quality data around the care subject.

For example, when it is determined that tossing and turning of the subject has occurred based on the obtained data regarding the movement of the care subject and at least one of the obtained temperature and humidity data and air quality data has changed, the processor 404 or 540 may select, as an environment improvement apparatus capable of improving the environment around the care subject, the air conditioner 130 connected through the communicator 403 or 530 and the first communication network 120.

For example, when it is determined that the subject has woken up from sleep based on the obtained data regarding the movement of the care subject, the processor 404 or 540 may select, as a care-related apparatus, the electric kettle 140 connected through the communicator 403 or 530 and the first communication network 120.

For example, when it is determined that a large number of people are detected around the care subject, based on the Wi-Fi CSI received through the communicator 403 or 530, the processor 404 or 540 of the monitoring apparatus 100 may determine the air conditioner 130 as an environment improvement apparatus to improve the air quality around the care subject.

In operation S740, the processor 404 or 540 of the monitoring apparatus 100 transmits an operation control signal to the determined external apparatus through the communicator 403 or 530. For example, when the determined external apparatus is an environment improvement apparatus, the processor 404 or 540 transmits, to the environment improvement apparatus, an operation control signal that may control the environment around the care subject to be pleasant. For example, when the environment improvement apparatus is the air conditioner 130, the operation control signal may include a signal for controlling wind strength and wind direction of the air conditioner 130. For example, when it is determined that a large number of people are detected around the care subject, the processor 404 or 540 may transmit, to the air conditioner 130, an operation control signal for the air conditioner 130 through the communicator 403 or 530 and the first communication network 120 such that wind strength and wind direction operations of the air conditioner 130 may be performed more quickly.

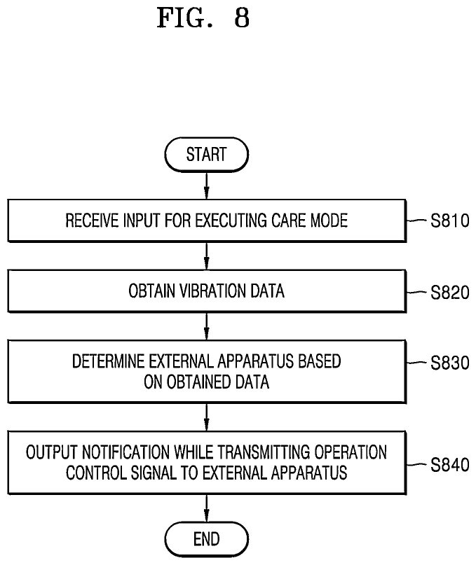

FIG. 8 is a flowchart for describing a method of controlling a monitoring apparatus 100, according to an embodiment of the present disclosure. The flowchart of FIG. 8 is an example of outputting a notification while controlling an external apparatus based on vibration data. The flowchart of FIG. 8 is performed when the monitoring apparatus 100 is capable of communicating, through the first communication network 120, with at least one external apparatus including the air conditioner 130 and/or the electric kettle 140. Connection between the monitoring apparatus 100 and the at least one external apparatus based on the first communication network 120 may be performed by the mobile device 150 or may be performed based on the input receiver 510 included in the monitoring apparatus 100.

In operation S810, the processor 540 of the monitoring apparatus 100 receives, through the input receiver 510, an input for selecting a care subject and an input for executing a care mode. The input for selecting the care subject and the input for executing the care mode may include a touch-based input or button-based input through the input receiver 510, as described with reference to FIGS. 4 and 5. The input for selecting the care subject and the input for executing the care mode may include an input based on an IR signal received from a remote controller (not shown).

In operation S820, in response to the inputs, the processor 540 of the monitoring apparatus 100 obtains vibration data obtained by detecting vibration around the care subject. The vibration data is provided from the vibration sensor 524. In operation S820, the processor 540 may further obtain data regarding a movement of the care subject, temperature and humidity data around the care subject, and air quality data around the care subject, as in operation S720. The data regarding the movement may be provided from Wi-Fi CSI received through the movement sensor 521 and/or the communicator 530. The temperature and humidity data may be provided from the temperature and humidity sensor 522. The air quality data may be provided from the air quality sensor 523. The processor 540 receives a sensing signal output from each of the movement sensor 521, the temperature and humidity sensor 522, the air quality sensor 523, and the vibration sensor 524 and obtains the data regarding the movement, the temperature and humidity data around the care subject, the air quality data around the care subject, and the vibration data around the care subject.

In operation S830, the processor 540 of the monitoring apparatus 100 may determine, based on the obtained vibration data, at least one external apparatus connected through the communicator 530. For example, when it is predicted that the care subject has woken up from sleep based on the obtained vibration data, the processor 540 may determine the air conditioner 130 as an apparatus to be controlled, to control the environment around the care subject to change to a normal mode of the care subject.

In operation S830, the processor 540 of the monitoring apparatus 100 may determine at least one external apparatus connected through the communicator 530, based on at least one of the obtained vibration data, data regarding the movement of the care subject, temperature and humidity data around the care subject, and air quality data around the care subject. For example, when it is predicted that the care subject is tossing and turning during sleep based on the obtained vibration data, the processor 540 may determine the air conditioner 130 as an apparatus to be controlled, to control the environment around the care subject to be more pleasant than the current state.

In operation S840, the processor 540 of the monitoring apparatus 100 transmits an operation control signal to the determined external apparatus through the communicator 530. For example, when the determined external apparatus is the air conditioner 130, the processor 540 transmits, to the air conditioner 130, an operation control signal for controlling a wind strength and/or wind direction operation of the air conditioner 130 based on at least one of the obtained temperature and humidity data and air quality data around the subject.

In operation S840, the processor 540 of the monitoring apparatus 100 may output a notification while transmitting the operation control signal to the determined external apparatus. The processor 540 may control the outputter 560 to output a notification through the outputter 560 included in the monitoring apparatus 100. The processor 540 may transmit a signal indicating a notification to the determined external apparatus through the communicator 530 such that the notification is output through the external apparatus. The notification may include a notification for notifying the current state of the care subject, a notification for notifying the current environmental state around the care subject, and a notification for notifying a controlled external apparatus and control details of the external apparatus, but is not limited thereto.

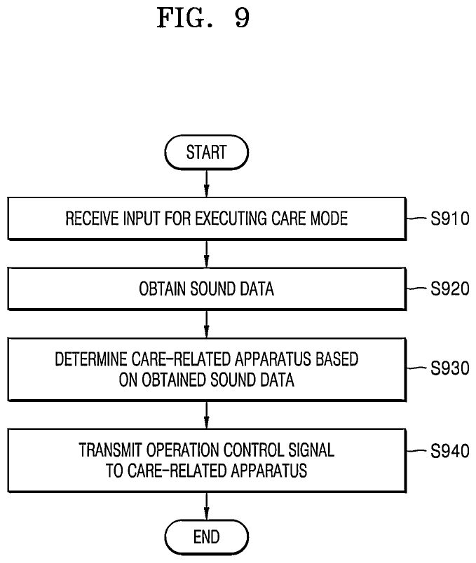

FIG. 9 is a flowchart for describing a method of controlling a monitoring apparatus 100, according to an embodiment of the present disclosure. FIG. 9 is an example illustrating a method of controlling the monitoring apparatus 100 that controls an operation of an external apparatus based on sound data. The flowchart of FIG. 9 is performed when the monitoring apparatus 100 is capable of communicating, through the first communication network 120, with at least one external apparatus including the air conditioner 130 and/or the electric kettle 140. Connection between the monitoring apparatus 100 and the at least one external apparatus based on the first communication network 120 may be performed by the mobile device 150 or may be performed based on the input receiver 510 included in the monitoring apparatus 100.

In operation S910, the processor 540 of the monitoring apparatus 100 receives an input for selecting a care subject and an input for executing a care mode for the care subject. The input for selecting the care subject and the input for executing the care mode for the care subject may include a touch-based input or button-based input through the input receiver 510, as described with reference to FIGS. 4 and 5. The input for selecting the care subject and the input for executing the care mode may include an input based on an IR signal received from a remote controller (not shown).

In operation S920, in response to the inputs, the processor 540 of the monitoring apparatus 100 obtains sound data obtained by the sound sensor 525. For example, the processor 540 receives sound data from the sound sensor 525.

In operation S930, the processor 540 of the monitoring apparatus 100 may determine, based on the obtained sound data, at least one external apparatus connected through the communicator 530. For example, the processor 540 may analyze the obtained sound data, by comparing the obtained sound data with data (e.g., a newborn's crying sound, a companion animal's crying sound, an elderly person's snoring sound, or a patient's groaning sound) stored in advance in the memory 550. Also, the processor 540 may analyze the obtained sound data by applying the obtained sound data to an artificial intelligence model. The processor 540 may determine, based on an analysis result, at least one external apparatus connected through the communicator 530.

For example, when a result of analyzing the received sound data is determined to indicate a crying sound of the newborn 110 and it is determined that it is time to feed the newborn 110 based on history information about the newborn 110, which is stored in the memory 550, the processor 540 may determine, as an external apparatus to be controlled, the electric kettle 140 connected through the first communication network 120.

For example, when a result of analyzing the received sound data is determined to indicate crying sound of the companion animal 111-1 or 111-2 and it is determined that the time is to provide feed to the companion animal 111-1 or 111-2 based on history information about the companion animal 111-1 or 111-2, which is stored in the memory 550, the processor 540 may determine, as an external apparatus to be controlled, an automatic feeding station for companion animals connected through the first communication network 120.

For example, when a result of analyzing the received sound data is determined to indicate snoring sound of the elderly person 112 and it is determined that the use of a humidifier is necessary based on history information about snoring of the elderly person 112, which is stored in the memory 550, the processor 540 may determine, as an external apparatus to be controlled, a humidifier connected through the first communication network 120.

For example, when a result of analyzing the received sound data is determined to indicate groaning sound of the patient 113 and it is determined that medical treatment is necessary based on history information about groaning sound of the patient 113, which is stored in the memory 550, the processor 540 may determine, as an external apparatus to be controlled, a medical robot or a mobile device of a medical practitioner, which is connected through the first communication network 120.

In operation S940, the processor 540 of the monitoring apparatus 100 transmits an operation control signal to the determined external apparatus. For example, when the care subject is the newborn 110 and the determined external apparatus is the electric kettle 140, the processor 540 may transmit a heating operation control signal to the electric kettle 140 through the communicator 530. Accordingly, the electric kettle 140 starts performing a heating operation. When there is no water in the electric kettle 140, the electric kettle 140 may output a notification. When a heating temperature reaches a set temperature (e.g., 40° C.), the electric kettle 140 may output a notification and stop the heating operation. The history information about the newborn 110, which is stored in the memory 550, may include hourly body temperature information, feeding time information and/or bedtime information about the newborn 110, but is not limited thereto.

For example, when the care subject is the companion animal 111-1 or 111-2 and the determined external apparatus is an automatic feeding station for companion animals, the processor 540 may transmit an automatic feeding control signal to the automatic feeding station for companion animals through the communicator 530. Accordingly, the automatic feeding station for companion animals starts performing a feed supply operation. When there is no feed to be supplied to the automatic feeding station for companion animals, the automatic feeding station for companion animals may output a notification. The history information about the companion animal 111-1 or 111-2, which is stored in the memory 550, may include feeding time information and/or bedtime information about the companion animal 111-1 or 111-2, but is not limited thereto.

For example, when the care subject is the elderly person 112 and the determined external apparatus is a humidifier, the processor 540 may transmit an operation control signal to the humidifier through the communicator 530. Accordingly, the humidifier may start a humidification operation. When the humidifier is operating, the operation control signal transmitted to the humidifier may be a signal for controlling an operation level of the humidifier. The history information about the elderly person 112, which is stored in the memory 550, may include bedtime information and/or information about snoring sound in sleep about the elderly person 112, but is not limited thereto.

For example, when the care subject is the patient 113 and the determined external apparatus is a mobile device of a medical practitioner, the processor 540 may transmit, to the mobile device of the medical practitioner, through the communicator 530, an operation control signal for outputting a notification that notifies the condition of the patient 113. Accordingly, the medical practitioner may identify the condition of the patient and quickly perform medical treatment through his or her mobile device. The history information about the patient 113, which is stored in the memory 550, may include groaning sound pattern information and/or information about the number of occurrence of groaning sound, but is not limited thereto.

Operations S920, S930, and S940 shown in FIG. 9 may be added to the flowchart of FIG. 7. For example, the monitoring apparatus 10 may control an operation of the external apparatus as in the flowchart of FIG. 7 based on at least one of data regarding a movement of the care subject, temperature and humidity data around the care subject, and air quality data around the care subject, and then control the operation of the external apparatus based on operations S920, S930, and S940 shown in FIG. 9.

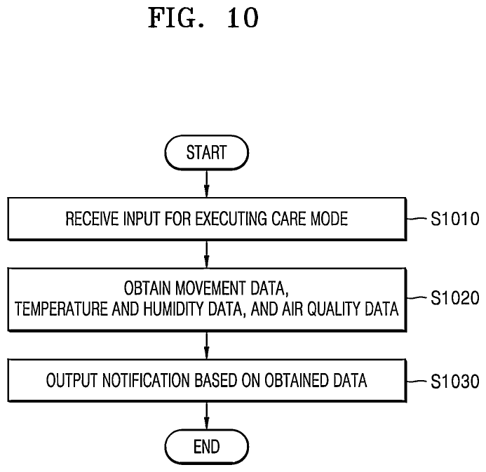

FIG. 10 is a flowchart for describing a method of controlling a monitoring apparatus 100, according to an embodiment of the present disclosure. FIG. 10 is an example of outputting a notification based on detected data. The flowchart of FIG. 10 is performed when the monitoring apparatus 100 is capable of communicating, through the first communication network 120, with at least one external apparatus including the air conditioner 130 and/or the electric kettle 140. Connection between the monitoring apparatus 100 and the at least one external apparatus based on the first communication network 120 may be performed by the mobile device 150 or may be performed based on the input receiver 510 included in the monitoring apparatus 100.

In operation S1010, the processor 540 of the monitoring apparatus 100 receives, through the input receiver 510, an input for selecting a care subject and an input for executing a care mode for the selected care subject. The input for selecting the care mode and the input for executing the care mode for the selected care subject may include a touch-based input or button-based input through the input receiver 510, as described with reference to FIGS. 4 and 5. The input for selecting the care subject and the input for executing the care mode for the care subject may include an input based on an IR signal received from a remote controller (not shown).

In operation S1020, in response to the inputs, the processor 540 of the monitoring apparatus 100 obtains data regarding a movement of the care subject, temperature and humidity data around the care subject, and air quality data around the care subject. The data regarding the movement of the care subject is provided from the movement sensor 521. The temperature and humidity data around the care subject is provided from the temperature and humidity sensor 522. The air quality data around the care subject is provided from the air quality sensor 523. The processor 540 receives a sensing signal output from each of the movement sensor 521, the temperature and humidity sensor 522, and the air quality sensor 523 and obtains the data regarding the movement of the care subject, the temperature and humidity data around the care subject, and the air quality data around the care subject.

In operation S1020, the processor 540 may obtain movement detection data by using Wi-Fi CSI extracted from a Wi-Fi signal received through the communicator 530. The processor 540 may detect the number of people around the care subject by using the extracted Wi-Fi CSI.

In operation S1030, when it is determined that the care subject needs to be taken care of based on the obtained data, the processor 404 or 540 of the monitoring apparatus 100 outputs a notification through the outputter 560. The notification output through the outputter 560 may include a display message based on the display 561 and a sound signal based on the sound outputter 562, but is not limited thereto. For example, when a breathing state of the newborn 110 is determined to be abnormal based on the obtained data, the processor 540 may output, through the outputter 560, a notification indicating that the breathing state of the newborn 110 is abnormal. For example, the processor 540 may also display the notification on the display 561 and output the notification in speech through the sound outputter 562.

Also, in operation S1030, when the breathing state of the newborn 110 is determined to be abnormal based on the obtained data, the processor 540 may output the notification, determine an external apparatus capable of requesting emergency dispatch assistance, and transmit an operation control signal to the determined external apparatus through the communicator 530. Accordingly, emergency dispatch assistance can be automatically received in an emergency situation.

Operation S1030 of FIG. 10 may be added after operation S720 or S730 of FIG. 7. When operation S1030 of FIG. 10 is added after operation S720 or S730 of FIG. 7, the monitoring apparatus 100 may output the notification through the outputter 560 of the monitoring apparatus 100 while controlling the external apparatus. The monitoring apparatus 100 may control the external apparatus and in an emergency situation, automatically request an emergency dispatch service while outputting the notification through the outputter 560 of the monitoring apparatus 100.

Also, operation S1030 of FIG. 10 may be added after operation S820 or S830 of FIG. 8. When operation S1030 of FIG. 10 is added after operation S820 or S830 of FIG. 8, the monitoring apparatus 100 may control the external apparatus and in an emergency situation, automatically request an emergency dispatch service while outputting the notification through the outputter 560 of the monitoring apparatus 100.

Also, operation S1030 of FIG. 10 may be added after operation S920 or S930 of FIG. 9. When operation S1030 of FIG. 10 is added after operation S920 or S930 of FIG. 9, the monitoring apparatus 100 may output the notification through the outputter 560 of the monitoring apparatus 100 while controlling the external apparatus. The monitoring apparatus 100 may control the external apparatus and in an emergency situation, automatically request an emergency dispatch service while outputting the notification through the outputter 560 of the monitoring apparatus 100.

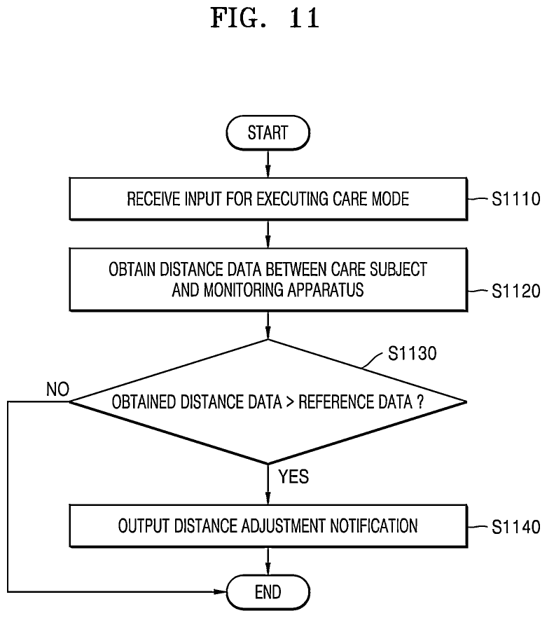

FIG. 11 is a flowchart for describing a method of controlling a monitoring apparatus 100, according to an embodiment of the present disclosure. FIG. 11 is an example of adjusting a distance between the monitoring apparatus 100 and the care subject. The flowchart of FIG. 11 is performed when the monitoring apparatus 100 is capable of communicating, through the first communication network 120, with at least one external apparatus including the air conditioner 130 and/or the electric kettle 140. Connection between the monitoring apparatus 100 and the at least one external apparatus based on the first communication network 120 may be performed by the mobile device 150 or may be performed based on the input receiver 510 included in the monitoring apparatus 100.

In operation S1110, the processor 540 of the monitoring apparatus 100 receives an input for selecting a care subject and an input for executing a care mode for the selected care subject. The input for selecting the care subject and the input for executing the care mode for the care subject may include a touch-based input or button-based input through the input receiver 510, as described with reference to FIGS. 4 and 5. The input for selecting the care subject and the input for executing the care mode for the care subject may include an input based on an IR signal received from a remote controller (not shown).

In operation S1120, in response to the inputs, the processor 540 of the monitoring apparatus 100 obtains distance data between the care subject and the monitoring apparatus 100. The processor 540 obtains the distance data by receiving sensing data output from the distance sensor 526. The distance sensor 526 may include at least one of an ultrasonic sensor, an IR sensor, a lidar sensor, a radar sensor, or a camera sensor.

In operation S1130, the processor 540 of the monitoring apparatus 100 compares the obtained distance data with reference data. The reference data is read from the memory 550 and used. The reference data is stored in advance in the memory 550 based on a distance at which the monitoring apparatus 100 may accurately detect a movement of the care subject. The reference data stored in the memory 550 may be modified based on an input received through the input receiver 510.

As a result of the comparison in operation S1130, when the obtained distance data is greater than the reference data, operation S1140 is performed, and the processor 540 outputs a distance adjustment notification through the outputter 560. The distance adjustment notification may include a notification to adjust the distance between the monitoring apparatus 100 and the care subject. For example, when a user places the monitoring apparatus 100 near the left side of a crib and a baby rolls near the right side of the crib during sleep, the processor 540 may output a notification message, “The monitoring apparatus has moved away from the care subject (newborn). Please adjust its position.” The distance adjustment notification may be output in the form of a speech guidance message. The distance adjustment notification may be output in the form of warning sound.

As a result of comparing the obtained distance data with the reference data in operation S1130, when the obtained distance data is not greater than the reference data, the processor 540 of the monitoring apparatus 100 ends the operation of FIG. 11.

Operations S1120 to S1140 may be repeatedly performed until a condition that the distance data between the monitoring apparatus 100 and the care subject is not greater than the reference data is satisfied.

Operations S1120 to S1140 of FIG. 11 may be added after operations S710, S810, S910, and S1010 shown in the flowcharts of FIGS. 7 to 10. When operations S1120 to S1140 of FIG. 11 are added after operations S710, S810, S910, and S1010 shown in the flowcharts of FIGS. 7 to 10, after the distance between the care subject and the monitoring apparatus 100 is adjusted, the monitoring apparatus 100 may detect the care subject and air quality.

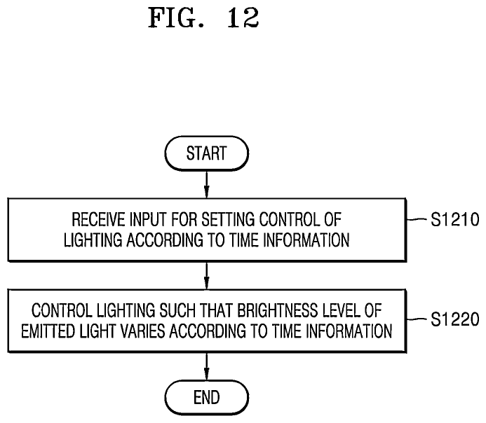

FIG. 12 is a flowchart for describing a method of controlling a monitoring apparatus 100, according to an embodiment of the present disclosure. FIG. 12 is an example of controlling the lighting 570 mounted on the monitoring apparatus 100. The flowchart of FIG. 12 is performed when the monitoring apparatus 100 is capable of communicating, through the first communication network 120, with at least one external apparatus including the air conditioner 130 and/or the electric kettle 140. Connection between the monitoring apparatus 100 and the at least one external apparatus based on the first communication network 120 may be performed by the mobile device 150 or may be performed based on the input receiver 510 included in the monitoring apparatus 100.

In operation S1210, the processor 540 of the monitoring apparatus 100 receives an input for setting control of the lighting 570 according to time information. The input for setting control of the lighting 570 is received through the input receiver 510.

In operation S1220, in response to receiving the input, the processor 540 of the monitoring apparatus 100 controls the lighting 570 such that a brightness level of emitted light varies according to time information. For example, the processor 540 may control the operation of the lighting 570 such that the brightness level of light emitted from the lighting 570 during the nighttime is higher than the brightness level of light emitted from the lighting 570 during the day. Nighttime information and daytime information may be stored in the memory 550, and the time information may be obtained by using a timer function included in the processor 540.

The flowchart of FIG. 12 may be added before operation S710, S810, S910, S1010, and S1110 in the flowchart of FIGS. 7 to 11. When the flowchart of FIG. 12 is added before operations S710, S810, S910, S1010, and S1110 in the flowchart of FIGS. 7 to 11, the monitoring apparatus 100 may perform the flowcharts of FIGS. 7 to 11 described above while controlling the brightness level of light through the lighting 570. Also, the processor 540 may control the operation of the lighting 570 according to detected air quality, as described with reference to FIG. 3.

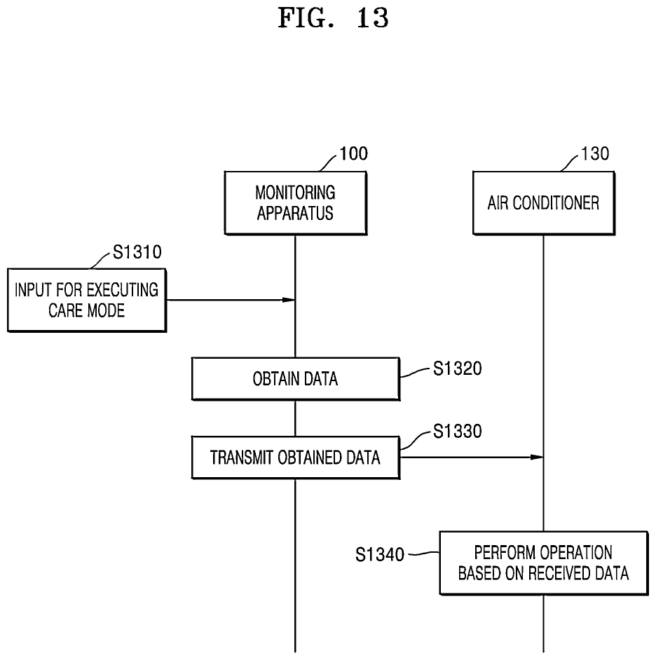

FIG. 13 is a flowchart for describing operations of an environment control system based on a monitoring apparatus 100 and an air conditioner 130, according to an embodiment of the present disclosure.

FIG. 13 is an example in which data obtained by the monitoring apparatus 100 is transmitted to the air conditioner 130, the air conditioner 130 determines environmental information around the monitoring apparatus 100 based on the received data, and the operation of the air conditioner 130 is performed based on a result of the determination. The flowchart of FIG. 13 is performed when the monitoring apparatus 100 is capable of communicating with the air conditioner 130 through the first communication network 120. Connection between the monitoring apparatus 100 and the air conditioner 130 based on the first communication network 120 may be performed by the mobile device 150 or may be performed based on the input receiver 401 or 510 included in the monitoring apparatus 100. FIG. 13 shows an example of an environment control system based on the connection between the monitoring apparatus 100 and the air conditioner 130, but the air conditioner 130 shown in FIG. 13 may include at least one of the environment improvement apparatus or the care-related apparatus, which are mentioned with reference to FIG. 1.

In operation S1310, the monitoring apparatus 100 receives an input for selecting a care subject and an input for executing a care mode for the selected care subject. The input for selecting the care subject and the input for executing the care mode for the care subject may include a touch-based input or button-based input through the input receiver 401 or 510, as described with reference to FIGS. 4 and 5. The input for selecting the care subject and the input for executing the care mode for the selected care subject may include an input based on an IR signal received from a remote controller (not shown).

In operation S1320, the monitoring apparatus 100 obtains data obtained by a sensor included in the monitoring apparatus 100 and/or data obtained by using Wi-Fi CSI received through the communicator 403 or 530.

In operation S1330, the monitoring apparatus 100 transmits the detected data to the air conditioner 130 through the communicator 403 or 530 and the first communication network 120. The air conditioner 130 analyzes the received detected data, determines, based on a result of the analysis, the state of the care subject and/or an environment (e.g., temperature and humidity data and air quality data) around the care subject, and when an external apparatus to be controlled is determined to be air conditioner 130 based on a result of the determination, transmits an operation control signal to the air conditioner 130.

Accordingly, in operation S1340, the air conditioner 130 may control a wind strength operation and/or a wind direction operation of the air conditioner 130 based on the received operation control signal.

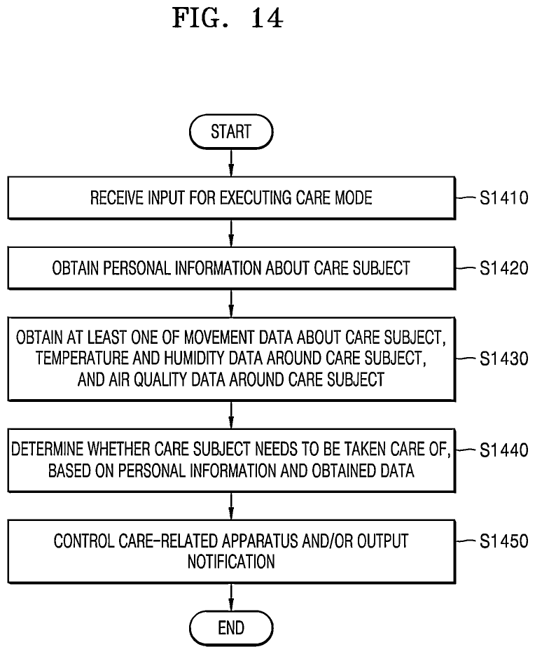

FIG. 14 is a flowchart for describing a method of controlling a monitoring apparatus 100, according to an embodiment of the present disclosure. FIG. 14 is an example of performing an operation of controlling a care-related apparatus based on personal information about the care subject and environmental information around the care subject and/or an operation of outputting a notification. The flowchart of FIG. 14 is performed when the monitoring apparatus 100 is capable of communicating, through the first communication network 120, with at least one external apparatus including the air conditioner 130 and/or the electric kettle 140. Connection between the monitoring apparatus 100 and the at least one external apparatus based on the first communication network 120 may be performed by the mobile device 150 or may be performed based on the input receiver 401 or 510 included in the monitoring apparatus 100.

In operation S1410, the processor 404 or 540 of the monitoring apparatus 100 receives, through the input receiver 401 or 510, an input for selecting a care subject and an input for executing a care mode for the selected care subject. The input for selecting the care mode and the input for executing the care mode for the selected care subject may include a touch-based input or button-based input through the input receiver 401 or 510, as described with reference to FIGS. 4 and 5. The input for selecting the care subject and the input for executing the care mode for the care subject may include an input based on an IR signal received from a remote controller (not shown).

In operation S1420, in response to the inputs, the processor 540 of the monitoring apparatus 100 obtains personal information about the care subject. The personal information about the care subject may be downloaded from the server apparatus 160 or input by a user through the input receiver 401 or 510. The personal information downloaded from the server apparatus 160 may include user history information or user profile information. The personal information about the care subject may include personal information about a companion animal. The personal information about the care subject may include the history information about the newborn 110, the history information about the companion animal 111-1 or 111-2, the history information about the elderly person 112, and the history information about the patient 113, which are mentioned with reference to FIG. 9, but is not limited thereto.

In operation S1430, the processor 404 or 540 or the monitoring apparatus 100 obtains at least one of data regarding a movement of the care subject, temperature and humidity data around the care subject, or air quality data around the care subject. The processor 404 or 540 may receive, from at least one sensor included in the monitoring apparatus 100, at least one of the data regarding the movement of the care subject, the temperature and humidity data around the care subject, or the air quality data around the care subject. The processor 404 or 540 may extract, from Wi-Fi CSI received through the communicator 403 or 530 included in the monitoring apparatus 100, at least one of the data regarding the movement of the care subject, the temperature and humidity data around the care subject, or the air quality data around the care subject.

In operation S1440, the processor 404 or 540 of the monitoring apparatus 100 determines whether the care subject needs to be taken care of, based on the personal information and the obtained data. For example, the care subject may be the newborn 110, and based on the personal information and the obtained data, the processor 100 may determine that the newborn 110 needs to be fed. For example, the care subject may be the elderly person 112, and based on the personal information and the obtained data, the processor 404 or 540 may determine that the elderly person 112 needs to be taken care of due to a fall. For example, the care subject may be the patient 113, and based on the personal information and the obtained data, the processor 404 or 540 may determine that the patient 113 needs fluid replacement (intravenous therapy).

In operation S1450, the processor 404 or 540 of the monitoring apparatus 100 controls the care-related apparatus or outputs a notification through the communicator 403 or 530, based on a result of the determination. Controlling the care-related apparatus through the communicator 403 or 530 may refer to transmitting an operation control signal for the care-related apparatus. Outputting the notification through the communicator 403 or 530 may refer to transmitting a signal indicating a notification such that the notification is output through the care-related apparatus. In operation S1450, the processor 404 or 540 may output the notification through the outputter 560 included in the monitoring apparatus 100.

Operations S1420 to S1450 of FIG. 14 may be added after operation S740 of FIG. 7.

According to an embodiment of the present disclosure, a monitoring apparatus 100 may include a communicator 403 or 530 configured to communicate with at least one external apparatus, a memory 402 or 550 storing one or more instructions, an input receiver 401 or 510 configured to receive an input for setting an operation mode, at least one sensor 405, 406, 407, or 520, and at least one processor 404 or 540.

According to an embodiment of the present disclosure, the at least one processor 404 or 540 may be configured to execute the one or more instructions to, through the input receiver 401 or 510, select a care subject 110, 111-1, 111-2, 112, or 113 and receive an input for executing a care mode for the selected care subject, in response to the received input, obtain, through the at least one sensor 405, 406, 407, or 520, at least one of data regarding a movement of the selected care subject, data regarding temperature and humidity around the selected care subject, or data regarding air quality around the selected care subject, based on at least one of the data regarding the movement of the selected care subject, the data regarding the temperature and humidity around the selected care subject, or the data regarding the air quality around the selected care subject, determine, from among the at least one external apparatus, an environment improvement apparatus capable of improving an environment around the selected care subject, and transmit, through the communicator 403 or 530, to the environment improvement apparatus, an operation control signal related to improving the environment around the selected care subject.

According to an embodiment of the present disclosure, the care mode may include a sleep mode of the selected care subject. According to an embodiment of the present disclosure, the at least one processor 404 or 540 may be further configured to, in the sleep mode of the selected care subject, based on the data regarding the movement of the selected care subject, detect a state of the selected care subject, determine the detected state of the care subject as at least one of an abnormal state, a tossing and turning state, or an awake state, and based on a result of the determination, determine the environment improvement apparatus and an operation control signal related to the environment improvement apparatus. According to an embodiment of the present disclosure, the operation control signal related to the environment improvement apparatus may include an operation control signal for controlling an operation of outputting a notification indicating the state of the selected care subject.

According to an embodiment of the present disclosure, the at least one sensor 405, 406, 407, or 520 may include a sound sensor 525 configured to detect a sound. According to an embodiment of the present disclosure, the at least one processor 404 or 540 may be further configured to, when an input for selecting a newborn 110 as the selected care subject is received, based on data regarding the sound detected by the sound sensor 525, determine a newborn care-related apparatus from among the at least one external apparatus, and transmit, through the communicator 403 or 530, to the newborn care-related apparatus, an operation control signal related to taking care of the newborn. According to an embodiment of the present disclosure, the newborn care-related apparatus may be different from the environment improvement apparatus.

According to an embodiment of the present disclosure, the at least one sensor 405, 406, 407, or 520 may include a vibration sensor 524 configured to detect a vibration around the selected care subject. According to an embodiment of the present disclosure, the monitoring apparatus 100 may include an outputter 560 configured to output a notification. According to an embodiment of the present disclosure, the at least one processor 404 or 540 may be further configured to, based on data regarding the vibration detected by the vibration sensor 524, determine the state of the selected care subject, and based on the state of the selected care subject, when it is determined that the selected care subject needs to be taken care of, output, through the outputter 560, a notification indicating that the selected care subject needs to be taken care of.

According to an embodiment of the present disclosure, the at least one processor 404 or 540 may be further configured to obtain personal information regarding the selected care subject, based on the personal information regarding the selected care subject and at least one of the data regarding the movement of the selected care subject, the data regarding the temperature and humidity around the selected care subject, or the data regarding the air quality around the selected care subject, determine whether the selected care subject needs to be taken care of, and transmit, through the communicator 403 or 530, to the at least one external apparatus, data indicating a notification.

According to an embodiment of the present disclosure, the monitoring apparatus 100 may further include an outputter 560 configured to output a notification, wherein the at least one processor 404 or 560 may be further configured to obtain, through the communicator 403 or 530, wireless-fidelity (Wi-Fi) channel state information, analyze the Wi-Fi channel state information, and when a breathing state of the selected care subject is predicted to be at least one of an abnormal state or a state in which the selected care subject has fallen, determine that the selected care subject needs to be taken care of, and output, through the outputter 560, a notification indicating that the selected care subject needs to be taken care of.

According to an embodiment of the present disclosure, the at least one processor 404 or 540 may be further configured to, when it is determined that the selected care subject needs to be taken care of, based on the state of the selected care subject, determine, from among the at least one external apparatus, a care-related apparatus for the selected care subject, and transmit, through the communicator 403 or 530, to the care-related apparatus for the selected care subject, an operation control signal related to taking care of the selected care subject.

According to an embodiment of the present disclosure, the monitoring apparatus 100 may further include a lighting 570 configured to emit light, wherein the at least one processor 404 or 540 may be further configured to control the lighting 570 such that a brightness level of light emitted from the lighting 570 varies according to time information.

According to an embodiment of the present disclosure, the monitoring apparatus 100 may further include a distance sensor 526 configured to measure distance data between the selected care subject and the monitoring apparatus 100, and an outputter 560 configured to output a notification, wherein the at least one processor 404 or 540 may be further configured to, when the distance data measured by the distance sensor 526 is greater than preset reference data, output a distance adjustment notification through the outputter 560.

According to an embodiment of the present disclosure, a method of controlling a monitoring apparatus 100 includes, by at least one processor 404 or 540 of the monitoring apparatus 100, receiving an input for selecting a care subject 110, 111-1, 111-2, 112, or 113 and executing a care mode for the selected care subject (S710, S810, S910, S1010, S1110, S1310, S1410), by the at least one processor 404 or 540, in response to the received input, obtaining, through at least one sensor 405, 406, 407, or 520 included in the monitoring apparatus 100, at least one of data regarding a movement of the selected care subject, data regarding temperature and humidity around the selected care subject, and data regarding air quality around the selected care subject (S720, S1020, S1320), by the at least one processor 404 or 540, based on at least one of the data regarding the movement of the selected care subject, the data regarding the temperature and humidity around the selected care subject, and the data regarding the air quality around the selected care subject, determining, from among at least one external apparatus, an environment improvement apparatus capable of improving an environment around the selected care subject, the at least one external apparatus being configured to communicate with a communicator 403 or 530 included in the monitoring apparatus 100 (S730, S830, S930), and by the at least one processor 404 or 540, transmitting, through the communicator 403 or 530, to the environment improvement apparatus, an operation control signal related to improving the environment around the selected care subject (S740, S940).

According to an embodiment of the present disclosure, the method of controlling the monitoring apparatus 100 may further include, by the at least one processor 404 or 540, when an input for selecting a newborn 110 as the selected care subject is received, based on sound data obtained by a sound sensor 525 included in the monitoring apparatus 100, determining a newborn care-related apparatus from among the at least one external apparatus (S930), and transmitting, through the communicator 403 or 530, to the newborn care-related apparatus, an operation control signal related to taking care of the newborn (S940), wherein the newborn care-related apparatus may be different from the environment improvement apparatus.

According to an embodiment of the present disclosure, the method of controlling the monitoring apparatus 100 may further include, by the at least one processor 404 or 540, obtaining, through a vibration sensor 524 included in the monitoring apparatus 100, vibration data around the selected care subject (S820), based on the obtained vibration data, determining a state of the selected care subject (S830), and based on the state of the selected care subject, when it is determined that the selected care subject needs to be taken care of, outputting, through an outputter 560 included in the monitoring apparatus 100, a notification indicating that the selected care subject needs to be taken care of (S840).

According to an embodiment of the present disclosure, the method of controlling the monitoring apparatus may further include, by the at least one processor 404 or 540, obtaining personal information regarding the selected care subject (S1420), by the at least one processor 404 or 540, based on the personal information regarding the selected care subject and at least one of the data regarding the movement of the selected care subject, the data regarding the temperature and humidity around the selected care subject, or the data regarding the air quality around the selected care subject, determining whether the selected care subject needs to be taken care of (S1440), and transmitting, through the communicator 403 or 530, to the at least one external apparatus, data indicating a notification (S1450).

According to an embodiment of the present disclosure, the method of controlling the monitoring apparatus 100 may further include, by the at least one processor 404 or 540, controlling a lighting 570 such that a brightness level of light emitted from the lighting 570 varies according to time information, the lighting 570 being included in the monitoring apparatus 100 (S1220).

According to an embodiment of the present disclosure, the method of controlling the monitoring apparatus 100 may further include, by the at least one processor 404 or 540, obtaining, by using a distance sensor 526 included in the monitoring apparatus 100, distance data between the selected care subject and the monitoring apparatus 100 (S1120), and by the at least one processor 404 or 540, when the obtained distance data is greater than preset reference data, outputting a distance adjustment notification through the outputter 560 included in the monitoring apparatus 100 (S1130, S1140).

A machine-readable storage medium may be provided in the form of a non-transitory storage medium. In this regard, the “non-transitory storage medium” simply means that the storage medium is a tangible apparatus and does not include a signal (e.g., an electromagnetic wave), but this term does not differentiate between where data is semi-permanently stored in the storage medium and where the data is temporarily stored in the storage medium. For example, the “non-transitory storage medium” may include a buffer in which data is temporarily stored.

According to an embodiment of the disclosure, the method according to various embodiments provided in the present document may be provided by being included in a computer program product. The computer program product may be traded as a product between a seller and a buyer. The computer program product may be distributed in the form of a machine-readable storage medium (e.g., a CD-ROM), or distributed (e.g., downloaded or uploaded) through an application store, or directly or online between two user apparatuses (e.g., smart phones). In the case of online distribution, at least a portion of a computer program product (e.g., a downloadable application) may be temporarily stored in a machine-readable storage medium, such as a memory of a manufacturer's server apparatus, an application store's server apparatus, or a relay server apparatus, or may be temporarily generated.

1. A monitoring apparatus, comprising:
a communicator configured to communicate with at least one external apparatus;
a memory to store one or more instructions;
an input receiver configured to receive an input setting an operation mode;
at least one sensor; and
at least one processor configured to execute the one or more instructions to,
through the input receiver, select a care subject to be monitored and receive an input to execute a care mode for the selected care subject,
in response to the received input, obtain, through the at least one sensor, sensed data including at least one of data regarding a movement of the selected care subject, data regarding temperature and humidity around the selected care subject, or data regarding air quality around the selected care subject,
based on the obtained sensed data, determine the at least one external apparatus is an environment improvement apparatus, or the at least one external apparatus is among the environment improvement apparatus enabled to control an environment around the selected care subject, and
transmit, through the communicator, to the environment improvement apparatus, an operation control signal related to improving the environment around the selected care subject.

2. The monitoring apparatus of claim 1, wherein the care mode comprises a sleep mode of the selected care subject, and
the at least one processor is further configured to,
during the sleep mode of the selected care subject, based on the data regarding the movement of the selected care subject, detect a state of the selected care subject,
determine the detected state of the care subject as at least one of an abnormal state, a tossing and turning state, or an awake state, and
based on a result of the determination of detected state of the care subject, determine the environment improvement apparatus and an operation control signal related to the environment improvement apparatus,
wherein the operation control signal related to the environment improvement apparatus comprises an operation control signal for controlling an operation of outputting a notification indicating the detected state of the selected care subject.

3. The monitoring apparatus of claim 1, wherein the at least one sensor comprises:
a sound sensor configured to detect a sound, and
the at least one processor is further configured to,
upon an input selecting a newborn as the selected care subject being received, based on data regarding the sound detected by the sound sensor, determine the at least one external apparatus is a newborn care-related apparatus or the at least one external apparatus is among the newborn care-related apparatus, and
transmit, through the communicator, to the newborn care-related apparatus, an operation control signal related to taking care of the newborn,
wherein the newborn care-related apparatus is different from the environment improvement apparatus.

4. The monitoring apparatus of claim 1, wherein the at least one sensor comprises:
a vibration sensor configured to detect a vibration around the selected care subject,
the monitoring apparatus further comprises:
an outputter configured to output a notification, and
the at least one processor is further configured to,
based on data regarding the vibration detected by the vibration sensor, determine a state of the selected care subject, and
based on the state of the selected care subject, upon determining the selected care subject needs to be taken care of, output, through the outputter, a notification indicating that the selected care subject needs to be taken care of.

5. The monitoring apparatus of claim 1, wherein the at least one processor is further configured to:
obtain personal information regarding the selected care subject,
based on the personal information regarding the selected care subject and at least one of the data regarding the movement of the selected care subject, the data regarding the temperature and humidity around the selected care subject, or the data regarding the air quality around the selected care subject, determine whether the selected care subject needs to be taken care of, and
transmit, through the communicator, to the at least one external apparatus, data indicating a notification.

6. The monitoring apparatus of claim 1, further comprising:
an outputter configured to output a notification,
wherein the at least one processor is further configured to:
obtain, through the communicator, wireless-fidelity (Wi-Fi) channel state information,
analyze the Wi-Fi channel state information, and based on a breathing state of the selected care subject being predicted to be at least one of an abnormal state or a state in which the selected care subject has fallen, determine that the selected care subject needs to be taken care of, and
output, through the outputter, a notification indicating that the selected care subject needs to be taken care of.

7. The monitoring apparatus of claim 6, wherein the at least one processor is further configured to,
upon determining the selected care subject needs to be taken care of, based on the state of the selected care subject, determine the at least one external apparatus is the environment improvement apparatus, or the at least one external apparatus is among a care-related apparatus for the selected care subject, and
transmit, through the communicator, to the care-related apparatus for the selected care subject, an operation control signal related to taking care of the selected care subject.

8. The monitoring apparatus of claim 1, further comprising
a lighting configured to emit light,
wherein the at least one processor is further configured to:
control the lighting such that a brightness level of light emitted from the lighting varies according to time information.

9. The monitoring apparatus of claim 1, further comprising:
a distance sensor configured to measure distance data between the selected care subject and the monitoring apparatus; and
an outputter configured to output a notification,
wherein the at least one processor is further configured to,
based on the distance data measured by the distance sensor being greater than preset reference data, output a distance adjustment notification through the outputter.

10. A method of controlling a monitoring apparatus, the method comprising:
by at least one processor of the monitoring apparatus configured to:
receive an input selecting a care subject to be monitored and execute a care mode for the selected care subject;
in response to the received input, obtain, through at least one sensor included in the monitoring apparatus, sensed data including at least one of data regarding a movement of the selected care subject, data regarding temperature and humidity around the selected care subject, and data regarding air quality around the selected care subject;
based on the obtained sensed data, determine at least one external apparatus is an environment improvement apparatus, or at least one external apparatus is among the environment improvement apparatus enabled to control an environment around the selected care subject, the monitoring apparatus including a communicator; and
transmitting, through the communicator, to the environment improvement apparatus, an operation control signal related to improving the environment around the selected care subject.

11. The method of claim 10, further comprising:
by the at least one processor, upon an input selecting a newborn as the selected care subject being received, based on sound data obtained by a sound sensor included in the monitoring apparatus, determine the at least one external apparatus is a newborn care-related apparatus or the at least one external apparatus is among the newborn care-related apparatus; and
transmitting, through the communicator, to the newborn care-related apparatus, an operation control signal related to taking care of the newborn,
wherein the newborn care-related apparatus is different from the environment improvement apparatus.

12. The method of claim 10, further comprising:
by the at least one processor, obtaining, through a vibration sensor included in the monitoring apparatus, vibration data around the selected care subject;
based on the obtained vibration data, determining a state of the selected care subject; and
based on the state of the selected care subject, upon determining the selected care subject needs to be taken care of, outputting, through an outputter included in the monitoring apparatus, a notification indicating that the selected care subject needs to be taken care of.

13. The method of claim 10, further comprising:
by the at least one processor,
obtaining personal information regarding the selected care subject;
based on the personal information regarding the selected care subject and at least one of the data regarding the movement of the selected care subject, the data regarding the temperature and humidity around the selected care subject, or the data regarding the air quality around the selected care subject, determining whether the selected care subject needs to be taken care of; and
transmitting, through the communicator, to the at least one external apparatus, data indicating a notification.

14. The method of claim 10, further comprising
by the at least one processor, controlling a lighting such that a brightness level of light emitted from the lighting varies according to time information, the lighting being included in the monitoring apparatus.

15. The method of claim 10, further comprising:
by the at least one processor,
obtaining, by using a distance sensor included in the monitoring apparatus, distance data between the selected care subject and the monitoring apparatus; and
based on the obtained distance data being greater than preset reference data, outputting a distance adjustment notification through an outputter included in the monitoring apparatus.
